(19) United States
(12) Patent Application Publication
(10) Pub. No.: US 2014/0113171 A1
(43) Pub. Date: Apr. 24, 2014

(54) ENERGY STORAGE APPARATUS, ENERGY STORAGE CELL AND HEAT-CONDUCTING ELEMENT WITH ELASTIC MEANS

(71) Applicant: Tim Schaefer, Harztor (DE)

(72) Inventor: Tim Schaefer, Harztor (DE)

(73) Assignee: LI-TEC BATTERY GMBH, Kamenz (DE)

(21) Appl. No.: 14/007,515

(22) PCT Filed: Mar. 16, 2012
(86) PCT No.: PCT/EP12/01187

§ 371 Date: Dec. 27, 2013

(30) Foreign Application Priority Data
Mar. 25, 2011 (DE) 10 2011 015 152.4

(51) Int. Cl. H01M 10/6555; H01M 10/63; H01M 10/625

(52) U.S. Cl. CPC H01M 10/5055; H01M 10/5016; H01M 10/502
USPC 429/120; 165/185

(57) ABSTRACT

The invention relates to an energy storage device, comprising a plurality of storage cells and a temperature-control device for the temperature-control of the storage cells or of a cell assembly formed by the storage cells, wherein elastic means for the shock-absorbing mounting or spacing are provided between a storage cell and another component, wherein the other component is another storage cell, a retaining element, another housing part or a heat-conducting element. The elastic means are designed and configured as a functional component of the temperature-control device. The invention also relates to storage cells and heat-conducting elements which are suitable for use in the energy storage device according to the invention.

The entire content of the DE 10 2011 015 152.4 priority application is herewith referenced as an integral part of the present application.

The invention relates to an energy storage apparatus, an energy storage cell and a heat-conducting element.

It is known that a battery for use in motor vehicles, particularly motor vehicles having a hybrid drive or in electric vehicles, has a plurality of cells connected in series and/or parallel, for example lithium ion cells.

The cells must often be cooled in order to dissipate the thermal losses which occur. To this end, it is known to make use of indirect cooling via a coolant circuit or direct cooling by means of pre-cooled air directed between the cells. In the case of cooling by means of the coolant circuit, a metallic cooling plate through which coolant flows can be disposed on the battery's cell block, often underneath the cells. The heat loss is directed from the cells to the cooling plate for example either via separate heat-conducting elements, e.g. heat-conducting rods or heat conduction plates, or via correspondingly thickened cell housing walls. Cell housings of cells are frequently metallic and subject to electrical voltage. To prevent short circuits, the cooling plate is then separated from the cell housings by electrical insulation, for example a thermally conductive foil, a molding, a casting compound or a coating or film applied to the cooling plate. The coolant circuit can also be used to warm up the battery, e.g. from a cold start.

Various such batteries are already known. For example, known from DE 10 2008 034 869 A1 are batteries having cells formed as so-called pouch cells, their substantially rectangularly-shaped active part being sandwiched within a casing film (or a pair of casing films) and tightly sealed, wherein the casing film forms a peripheral sealed seam and wherein the cell poles are formed by connectors which pass through the sealed seam at the top of the cells and protrude upward. Heat sinks are disposed between the cells which bear against the flat sides of the cells, are each angled below the cells and rest against a cooling plate there. The heat sinks can transfer the heat generated in the cell to the cooling plate. A heat transfer medium flows through the cooling plate and transports the heat to an external heat exchanger. Batteries are known from the same printed publication having cells formed as so-called flat cells of substantially rectangular shape which are stacked one behind the other on a cooling plate and braced to same, whereby a respective electrically conductive side wall of the cells serving as the cell pole is angled on the bottom side facing the cooling plate so as to form the largest heat transfer surface possible to the cooling plate disposed there. In both cases, the cells are braced together and pressed against the cooling plate by a clamping device, for example by a separate clamping plate and/or by tension bands.

A battery is known from WO 2010/081704 A2 in which a plurality of coffee bag-designed cells are clamped by means of two pressure frames and a number of tension bars. Providing elastic elements between successive cells in a battery pack is known from the same citation. Thus, also mechanical forces on the flat sides of the cells can be cushioned and relative motions as well as also thermal expansions equalized.

It is an object of the present invention to improve upon the prior art configuration.

This object is accomplished by the features of the independent claims. Advantageous further developments of the invention constitute the subject matter of the subclaims.

In accordance with the invention, an energy storage apparatus is provided which comprises a plurality of storage cells and a temperature control device for controlling the temperature of the storage cells or a cell assembly formed by the storage cells, wherein elastic means are provided preferably between a storage cell and another component for a shock-absorbing supporting or spacing, wherein the other component is another storage cell or a retaining element or another housing part or a heat-conducting element, and wherein said elastic means is designed so as to exert a defined pressure on one or more of the storage cells.

An energy storage apparatus in the sense of the invention is to be understood as a device which is also capable of absorbing in particular electrical energy, storing it and then releasing it again, preferably utilizing electrochemical processes. A storage cell in the sense of the invention is to be understood as a self-contained functional unit of the energy storage apparatus which in itself is also capable of absorbing in particular electrical energy, storing it and then releasing it again, preferably utilizing electrochemical processes, particularly preferably based on the electrochemical properties of lithium. A storage cell can for example, but not solely, be a galvanic primary or secondary cell (in the context of the present application, primary or secondary cells are indiscriminately referred to as battery cells and an energy storage apparatus composed therefrom as a battery), a fuel cell, a high-performance capacitor such as for instance a supercap or the like, or a different type of energy storage cell. Particularly, a storage cell designed as a battery cell comprises for example an active section or active part in which electrochemical conversion and storing processes occur, a casing to encapsulate the active part from the environment and at least two current conductors which serve as the electrical poles of the storage cell. The active part comprises for example an electrode array configured preferably as a stack or a coil with current collector films, active layers and separator layers. The active and separator layers can be at least partially provided as separate pre-cut films or as coatings on the current collector films. The current conductors are electrically connected to or formed by the current collector films.

Temperature regulation in the sense of the invention refers to a removal or supply, particularly a removal, of heat. It can be realized as passive cooling, for instance by thermal radiation at heat radiating surfaces, as active cooling, for instance by forced convection at heat transfer surfaces, or by heat transfer with a particularly circulating heat transfer medium such as for instance water, oil or the like in a heat exchanger. A control and/or regulation can thereby be provided in order to maintain a predefined allowable temperature range. Temperature regulation in the sense of the invention can be understood as a device just for thermal exchange within the energy storage apparatus or for exchanging heat with an environment.

Elastic means in the sense of the invention is to be understood in particular as a structural element which can absorb also relative motion between storage cells, also between storage cells and other structural elements as needed. It can thus in particular be a damping element, for example, but not solely, in the form of a cushion, a strip, a layer or the like. Preferably, an elastic means in the sense of the present invention is designed and disposed so as to exert a pressure on its environment, particularly also indirectly or directly on one or more of the storage cells.

A defined pressure in the present context is to be understood as a pressure having values within a predefined range, its upper/lower limiting values not being exceeded or fallen short of during the intended operation of the inventive energy-saving apparatus. The exact values to said limiting values are dependent on the underlying technology on which the inventive energy-saving apparatus is based and are selected such that the proper operation of an inventive energy-saving apparatus can be expected within said limiting values. They can additionally be dependent on other operating parameters, such as for example the temperature in the interior, at the surface or in the environment of the storage cells constituting the energy-saving apparatus.

Preferably, the elastic means are designed and disposed as a functional component of the temperature control device. Doing so enables overcoming constructional limitations in terms of the position and use of such elastic means. Such limitations often exist as damping elements often consist of thermally insulating materials exhibiting very low heat conductivity such as for instance PU foam, foam rubber, corrugated cardboard or the like and thus can hinder efficient heat dissipation.

According to one preferred embodiment of the invention, at least one elastic means is convexly or concavely adapted to the shape of the cells such that the pressure exerted by said elastic means is changed or sustained so that the magnitude of the pressure which the elastic means exerts on one or more storage cells will not exceed and/or fall short of an upper/lower limiting value during the intended operation of the inventive energy storage apparatus.

It is particularly preferable for the elastic means to be convexly or concavely adapted to the shape of the cells such that—preferably as a function of the pressure conditions prevailing at that moment—the pressure can be increased or decreased.

It is particularly preferable for the elastic means to be realized in such a manner which leads to the outer form and thus in particular the size of the contact surface(s) of at least one elastic means with its environment changing upon the change in form of at least one storage cell such that the pressure the thusly designed elastic means exerts on its environment by means of said contact surface(s) is within a specific range, its upper/lower limiting value not being exceeded or fallen short of during the intended operation of the inventive energy storage apparatus.

Preferably, the elastic means is realized in such a manner as to result in the prevailing of a constant or virtually constant pressure. This can for example be achieved by a mass being coupled to a gas volume filling the interior of the elastic means under the influence of its own weight force such that the gas volume in the interior of the elastic means remains under a constant pressure. In this case, should a variable force press on the external shell of the elastic means from the outside, said external shell will then deform in such a way that at each value of said variable force, the ratio of the force and the size of the contact surface—contingent on the form of the outer shell—precisely corresponds to the constant pressure within the gas volume. A virtually constant pressure is a pressure of a magnitude within a specific range, its upper/lower limiting value not being exceeded or fallen short of when the inventive energy storage apparatus is operated as intended.

Alternatively thereunto, the elastic means is partially filled with a liquid which is in equilibrium with its vapor at the prevailing temperature so that the vapor of said liquid fills the part of the interior volume of the elastic means which is not filled by the liquid. The pressure inside the elastic means in this case results from the vapor pressure of the liquid which is a function of the prevailing temperature. Provided said temperature can remain constant or virtually constant, the pressure within the elastic means will also remain constant.

In one preferential embodiment, the elastic means can comprise a heat-conducting shell and an interior space, whereby the interior space is filled with an elastically resilient material. In a further preferential embodiment, the elastic means can be formed from a heat-conducting and elastically resilient material. In a further preferential embodiment, the elastic means can comprise a heat-conducting or heat permeable shell and an interior space, whereby the interior space is filled with a heat-conducting and elastically resilient material.

Heat conducting in the terms of the invention is to be understood as a material which exhibits a thermal conductivity allowing its use as a heat conductor in the technical sense. It refers in this context to a technically useful and constructionally intended thermal conductivity, not for instance also inherently heat-insulting materials, of minimum and physically unavoidable residual heat conduction. An acceptable lower limit for a technically useful thermal conductivity can be in the range of approximately 10-20 W m⁻¹ K⁻¹; which corresponds to the thermal conductivity of high-alloy steel and is consistent with plastics provided with good heat-conducting filler material. It is preferential for the thermal conductivity to be within the range of at least 40 to 50 W m⁻¹ K⁻¹, which corresponds to that of spring steel (e.g. 55Cr3). A thermal conductivity of at least 100 or several 100 m⁻¹ K⁻¹s particularly preferential. As an example, but not restrictively, silicon at 148 W m⁻¹ K⁻¹ oraluminum at 221-237 W m⁻¹ K⁻¹ orcopper at 240-400 W m⁻¹ K⁻¹ or silver at approximately 430 W m⁻¹ K⁻¹ could for instance be considered suitable. At a thermal conductivity of approximately 6000 W m⁻¹ K⁻¹, carbon nanotubes represent the current optimum attainable in terms of this criterion; their use, or that of other special materials, is to be weighed in terms of the costs, processability and any other technical suitability. Given this background, a design with a thermally conductive material is to be understood in the sense of the invention such that the elastic means or a component thereof either consists substantially of said material or else, for instance for reasons of rigidity, electrical insulation, thermal stability or other properties or applications, only a core, a coating, a layer, a casing or the like comprises such a material. Appropriately selecting the material combination thus allows for regulating the desired properties relative to thermal conduction and damping. The same materials as cited above, or also other materials which conduct heat well such as for instance ceramic or diamond, are conceivable as filler material for heat-conducting plastics. Hence, by doping with such materials, for instance intrinsically thermally insulating foam can gain a technically useful thermal conductivity in the range of approximately 10-20 W m⁻¹ K⁻¹. (All the specifications as to thermal conductivity at 20° C. pursuant Hütte, Die Grundlagen der Ingenieurwissenschaften, Springer-Verlag, 31st Ed. 2000; Engelkraut et al., Wärmeleitfähiqe Kunststoffe für Entwärmunqsaufqaben, Fraunhofer Institute for Integrated Systems and Device Technology, Jul. 15, 2008, Deutsche Edelstahlwerke data sheet 1.7176, and the 22.02.411 Wikipedia article on “thermal conductivity;” rounding and subject consolidation provided as applicable by this side.)

Good heat transfer is also attainable when the elastic means bears at least partially, preferably flatly, on the heat exchange surfaces of the storage cells.

A further advantage of elastic means with good thermal conduction properties is the possibility thereby established of keeping the temperature and thus also the pressure inside the elastic means constant, particularly in the embodiments of the elastic means which are partially filled with a liquid in which the prevailing temperature is in equilibrium with its vapor so that the vapor of this liquid fills the part of the interior volume of the elastic means which is not filled with liquid. The pressure inside the elastic means results in this case from the vapor pressure of the liquid which is dependent on the prevailing temperature. Provided said temperature can remain constant or virtually constant, the pressure within the elastic means will also remain constant.

In preferential developments, the elastic means are electrically conductive or electrically insulating in order to take for example technical limiting conditions into account. It is particularly preferable for the elastic means to comprise an at least partially electrically conductive or electrically insulating shell which is particularly preferably also a good thermal conductor.

In one preferential development, elastic means are affixed to respective storage cells or formed as integral components of respective storage cells.

In another preferential development, elastic means are affixed to respective heat-conducting elements or are formed as integral components of respective heat-conducting elements, at least sections of which are arranged between respective storage cells.

It is particularly preferential for the temperature control device to comprise a heat exchanger device and for heat-conducting elements, at least sections of which are arranged between respective storage cells, to have heat-conducting contact to the heat exchanger device.

A further preferential development provides for a clamping device for bracing the storage cells, wherein the clamping device is preferably designed and disposed as a functional component of the temperature control device. In the terms of the invention, a clamping is to be understood as a retaining in a predetermined position by tensioning force, particularly a relative position to one another. Elastic and frictional forces can, but not restrictively, also be used in clamping. The clamping does not incidentally exclude a form-locking position securing; it can be, albeit it is not imperative, to be limited to hindering components from coming apart. When the clamping device is preferably designed and disposed as a functional component of the temperature control device, the clamping device can also fulfill functions associated with controlling the temperature of the storage cells or the cell assembly respectively. The functions can include, albeit not restrictively, heat transfer from and to the storage cells, thermal radiation at heat radiating surfaces, heat transfer from and to a heat transfer medium, thermal conduction from and to a heat source or a heat sink, etc. The clamping device can for example be configured with a heat-conducting material to this end.

As an example, the clamping device comprises at least one tension band which is configured with the heat-conducting material and which is preferably of intrinsically resilient design, at least in sections, for instance formed as a wave spring, and/or comprises a Spannabschnitt such as for instance a turnbuckle or the like, wherein preferably a plurality of tension bands are provided, of which at least one tension band covers at least one other tension band. In the terms of the invention, a tension band is to be understood as an elongated, particularly flat, strap-like component which can also be used to brace an arrangement of storage cells against each other, particularly in a wrap-around bracing. A locking mechanism, a clamping mechanism or the like can thereby be provided to enable a tensioned assembly. An intrinsically resilient design can also achieve a uniform tensioning force being exerted on the cell block. An elastic elongation of the tension band can be configured such that the tension band can be oversized relative the cell block and stretched over same during tensioned assembly, whereby when the pretensioning then relaxes, the tension band tightly girdles the cell block. To this end, sections of the tension band can for example be of wave spring design. It is particularly preferential for the wave spring-formed sections to exhibit flat sections which bear against the heat exchange surfaces of storage cells, heat-conducting elements, etc. under tension.

In another development, the clamping device can comprise a plurality of tension bars formed from the heat-conducting material. To be understood as a tension bar in the terms of the invention is an elongated bar, particularly projecting the entire length of the cell stack, which in particular braces the cell block by means of pressure elements such as plates or flanges which press against the respectively outer storage cells in a stacking direction of the storage cells. A plurality of tension bars are normally provided, for instance four, six, eight or more. Such tension bars exhibit for example a head on one end and a thread on the other end or threads on both ends in order to enable reliable bracing upon tightening via screwing in or bolting with nuts. Making use of tension bars with appropriately designed storage cells also has the advantage that storage cells can be threaded onto the tension bar prior to the clamping in relatively simple fashion, which can also simplify assembly. Tension bars can for example extend through corresponding recesses in frame elements of flat-cell frames and absorb heat from same. The clamping device can thereby further comprise retaining elements and tensioning elements, whereby the retaining elements are disposed alternatingly with the storage cells so as to hold the storage cells between them, and whereby the tensioning elements brace the retaining elements to the storage cells, wherein at least sections of the retaining elements are thermally coupled to the heat exchange surfaces of the storage cells, and wherein at least sections of the tensioning elements bear on the heat exchange surfaces of the retaining elements. It is thereby advantageous for the retaining elements to be configured with a heat-conducting material at least between the contact surfaces with the storage cells and the contact surfaces with the tensioning elements. So doing also provides a reliable tensioning of the retaining elements and the storage cells into a battery block. Heat exchange surfaces of the retaining elements can be outer surfaces, particularly edge surfaces, of the retaining elements, for example, but not solely, when tension bands are provided as tensioning elements. Tensioning elements such as for example, but not solely, tension bars can also be guided through passages, for instance bores, in the retaining elements; in this case, heat exchange surfaces of the retaining elements can be formed by the inner surfaces of the passages. Storage cell heat exchange surfaces can be provided by flat or edge sides of the storage cells, by current conductors or at passage areas of current conductors through a housing of the storage cells.

It is thereby advantageous for at least sections of the clamping device to be thermally coupled to, particularly in flat contact with, sections of a heat exchange device, wherein the heat exchange device is preferably connected to a heat transfer medium circuit and wherein the heat transfer medium circuit can preferably be controlled/regulated. So doing enables the clamping device to convey the heat absorbed from the storage cells to the heat exchange device and release it there to a heat transfer medium such as for example, but not exclusively, water or oil. The heated heat transfer medium can circulate through the heat transfer medium circuit and give off the absorbed heat again at other points, for instance to an air cooler, etc.

In accordance with further aspects, an energy storage cell is proposed which is designed with an active part and an enclosure encasing said active part as well as with elastic means affixed to the storage cell or formed as an integral component thereof and designed and disposed for the shock-absorbing supporting or spacing of the storage cell relative to other components, a heat-conducting element to be arranged between energy storage cells, characterized by elastic means affixed to the heat-conducting element or formed as an integral component of same and designed and disposed to conduct heat, and a heat-conducting element having a particularly thin-walled support structure, particularly for receiving an energy storage cell, wherein the thin-walled structure defines a form of a preferably flat cuboid and wherein the thin-walled structure exhibits at least one flat side and at least two narrow sides flanking the flat side, and with elastic means affixed to the heat-conducting element or formed as an integral component thereof and designed and disposed to conduct heat. Preferably, the elastic means is in each case configured in accordance with the above description.

An inventive energy storage apparatus, an inventive energy storage cell and an inventive heat-conducting element are provided in particular for use in a motor vehicle, whereby the motor vehicle is in particular a hybrid or electric vehicle.

The preceding and further features, functions and advantages of the present invention will become considerably clearer from the following description which makes reference to the accompanying figures.

The figures show:

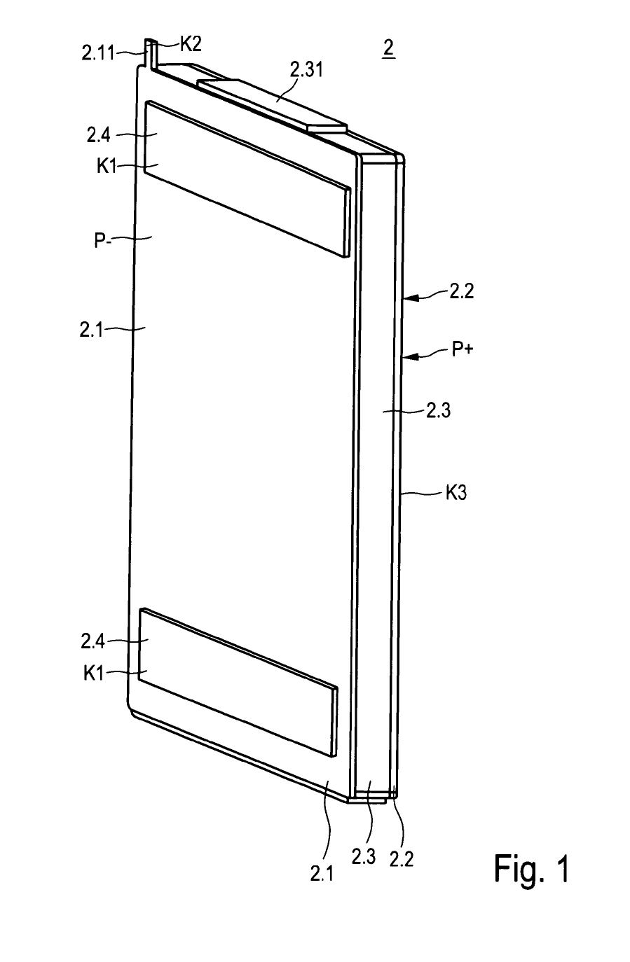

FIG. 1 a schematic spatial view of a flat-frame cell,

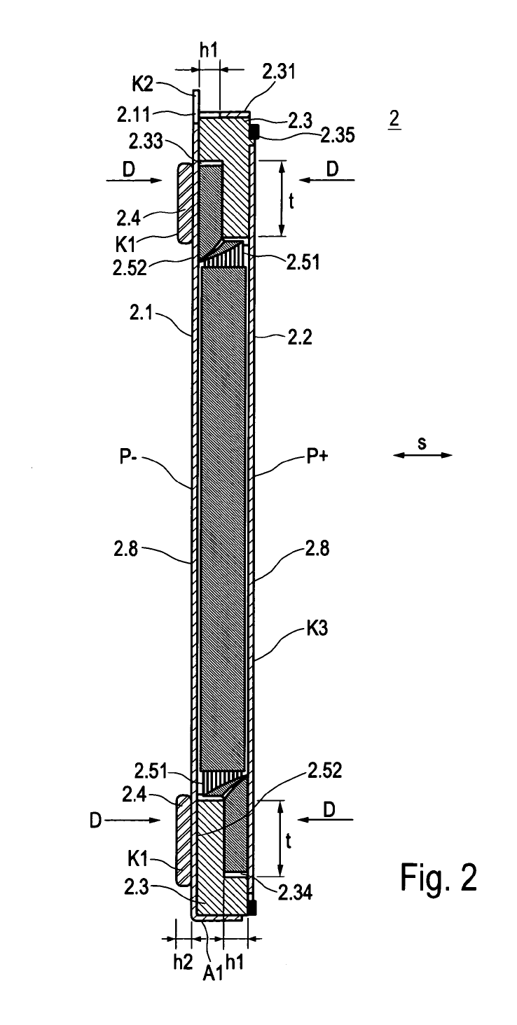

FIG. 2 a schematic cross-sectional view of the cell according to FIG. 1,

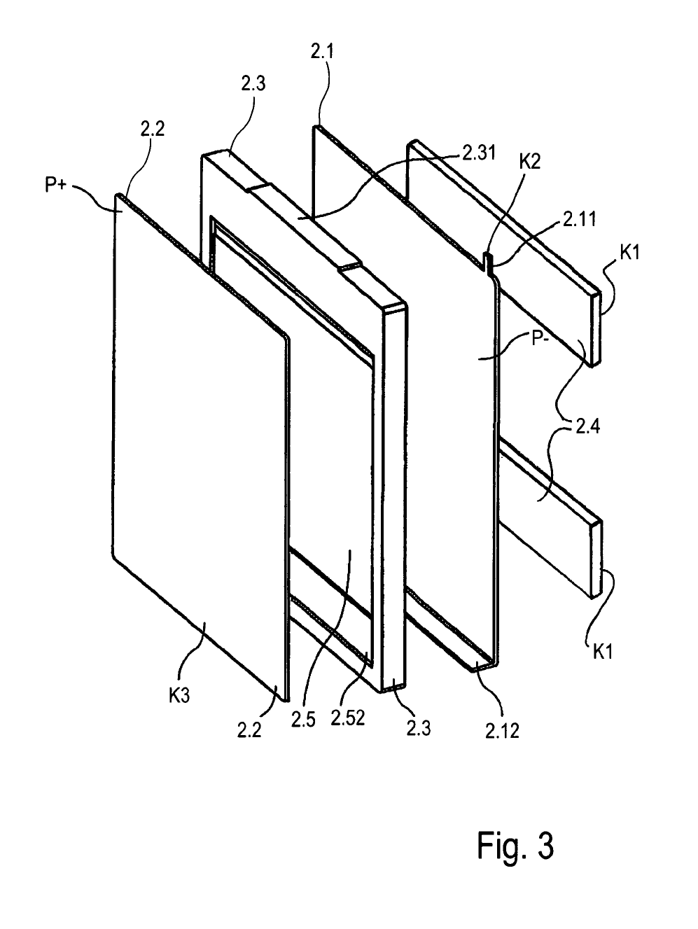

FIG. 3 an exploded schematic spatial view of the cell according to FIG. 1,

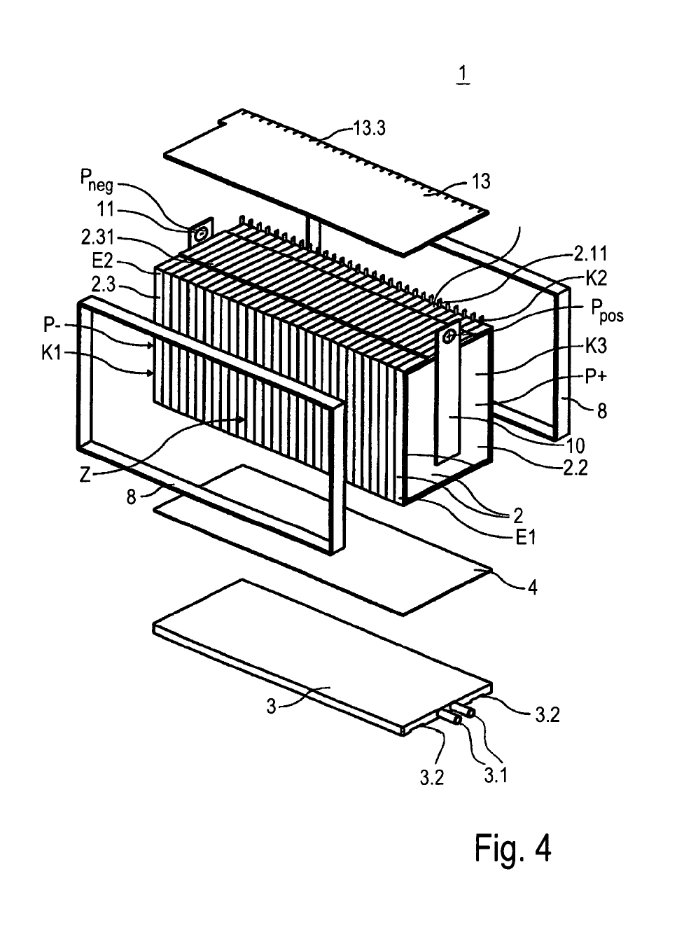

FIG. 4 an exploded schematic spatial view of a battery having a plurality of flat-frame cells,

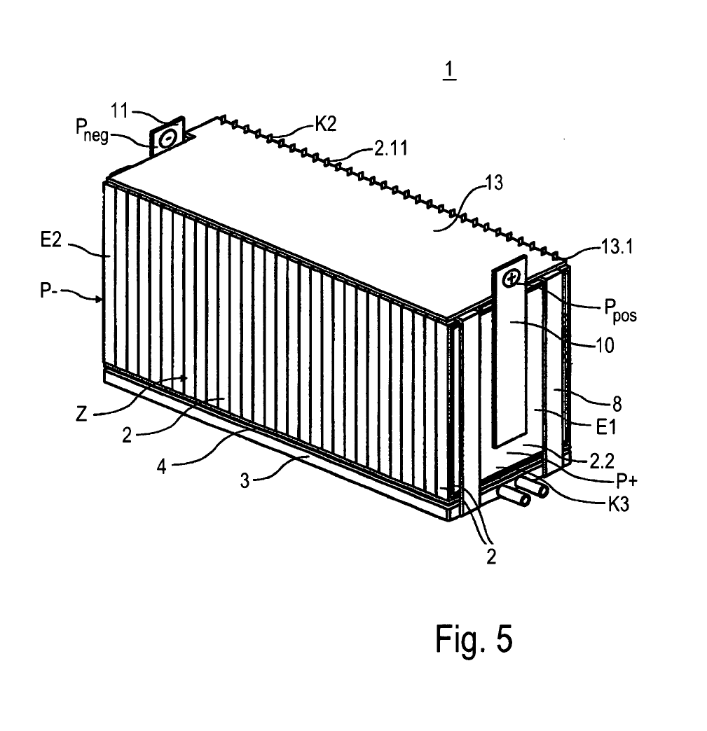

FIG. 5 a schematic spatial view of the battery according to FIG. 4 in an assembled state,

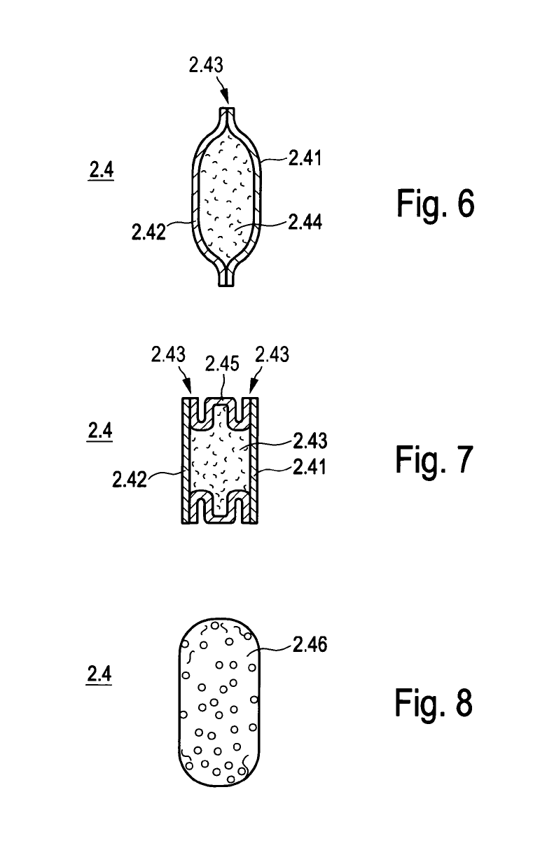

FIG. 6 a schematic cross-sectional view of a damping element,

FIG. 7 a schematic cross-sectional view of another damping element,

FIG. 8 a schematic cross-sectional view of a further damping element,

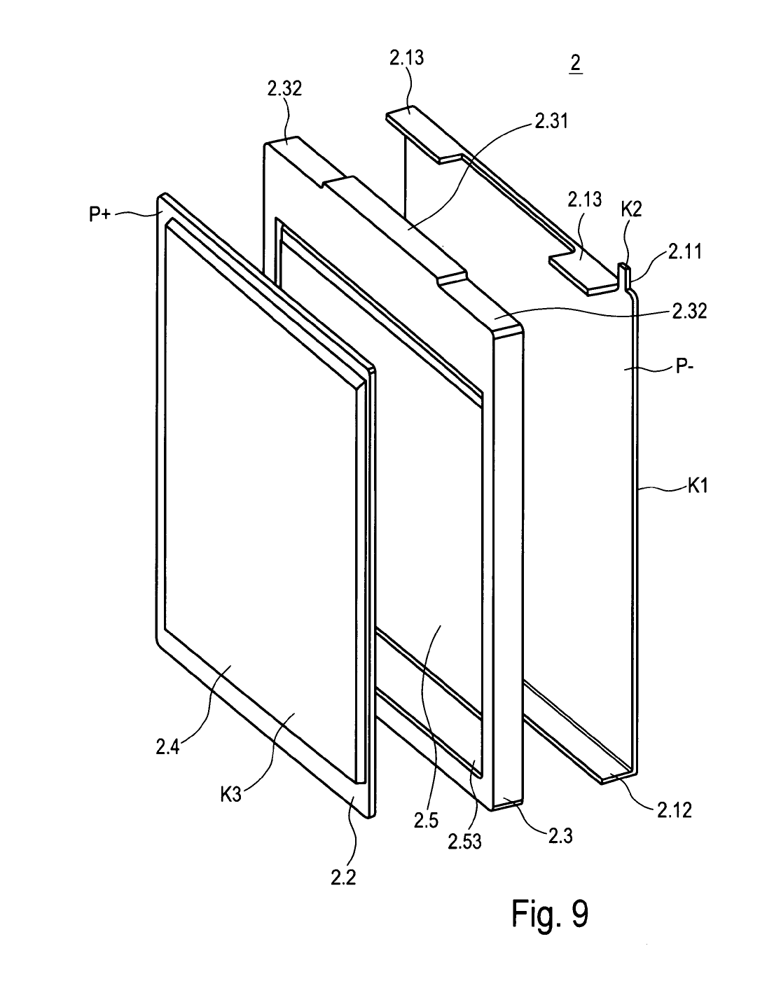

FIG. 9 an exploded schematic spatial view of a further flat-frame cell,

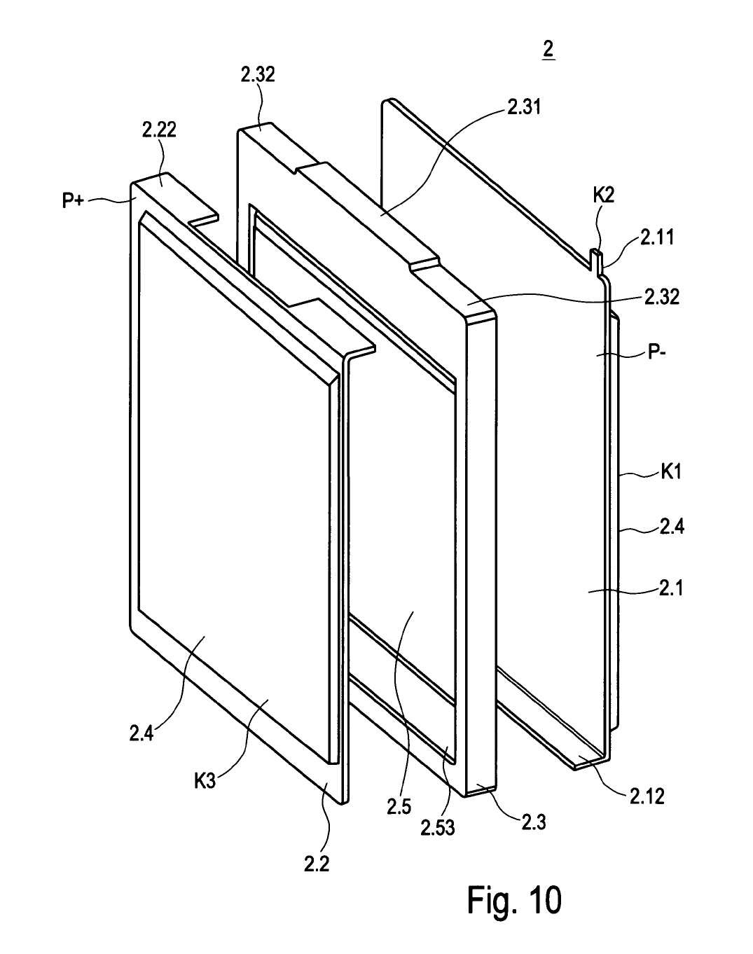

FIG. 10 an exploded schematic spatial view of a similar flat-frame cell,

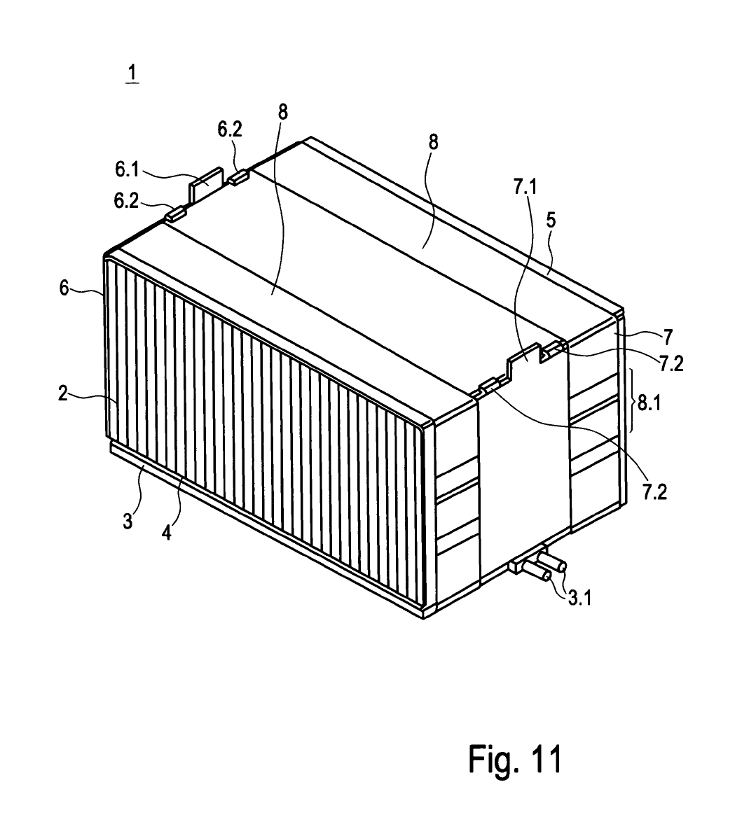

FIG. 11 a schematic spatial view of a further battery with flat-frame cells,

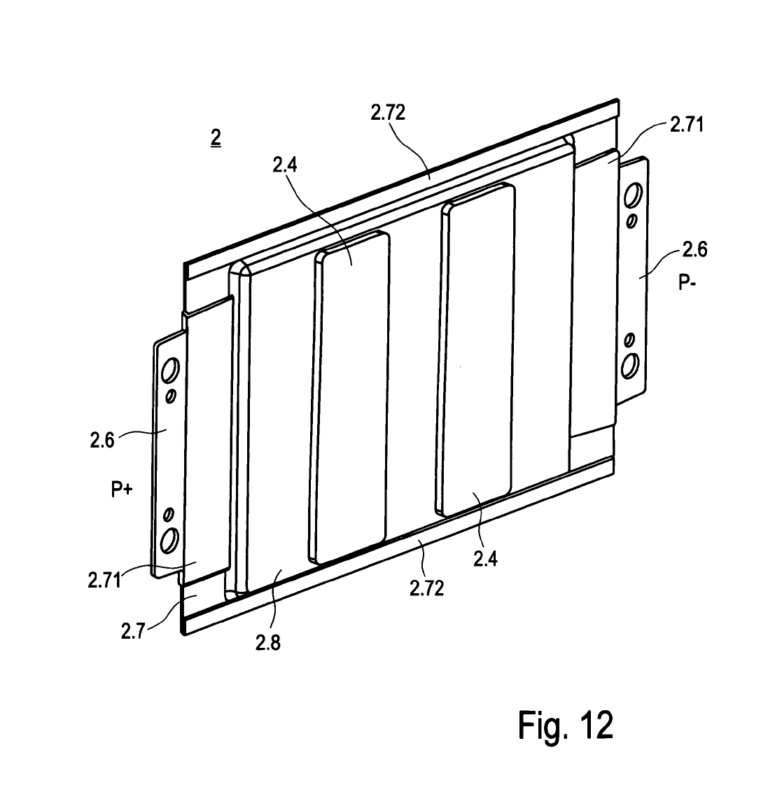

FIG. 12 a schematic spatial view of a pouch cell exhibiting damping elements,

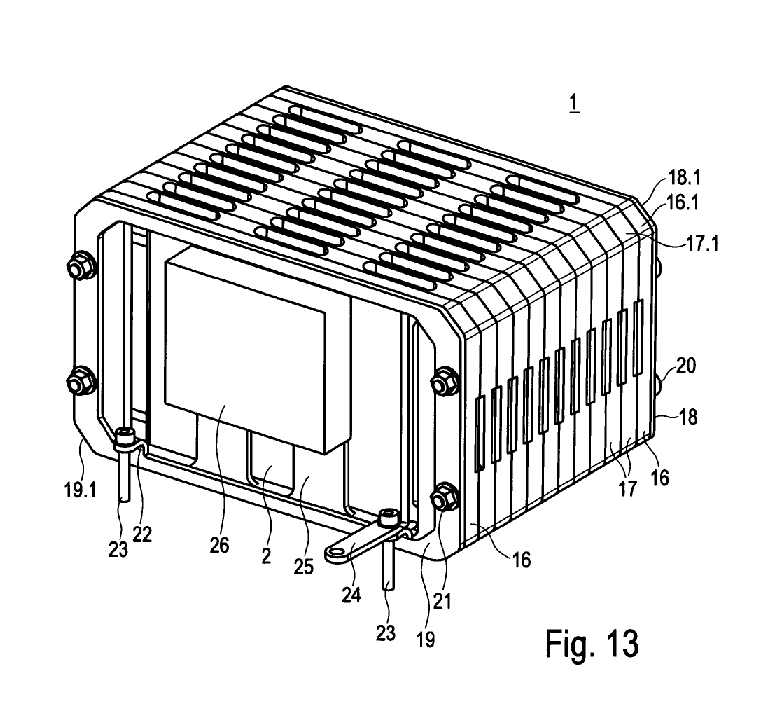

FIG. 13 a schematic spatial view of a plurality of pouch cells tensioned between frame elements by means of tension bars,

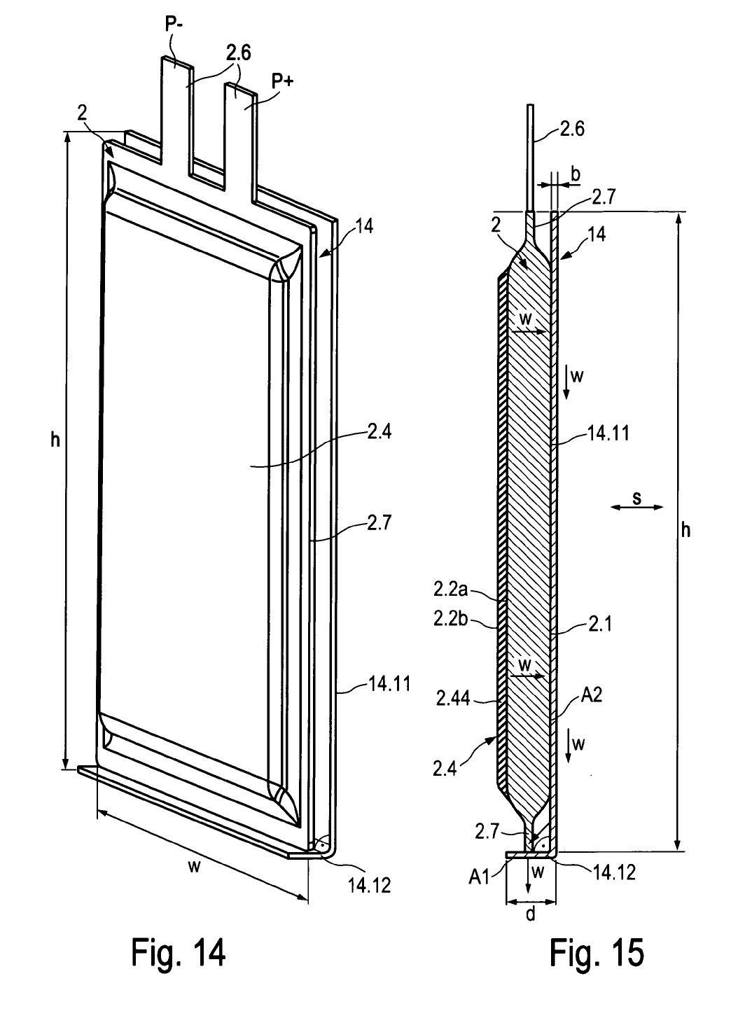

FIG. 14 a schematic spatial view of an individual cell and a heat-conducting element,

FIG. 15 a schematic cross-sectional view of an individual cell and a heat-conducting element,

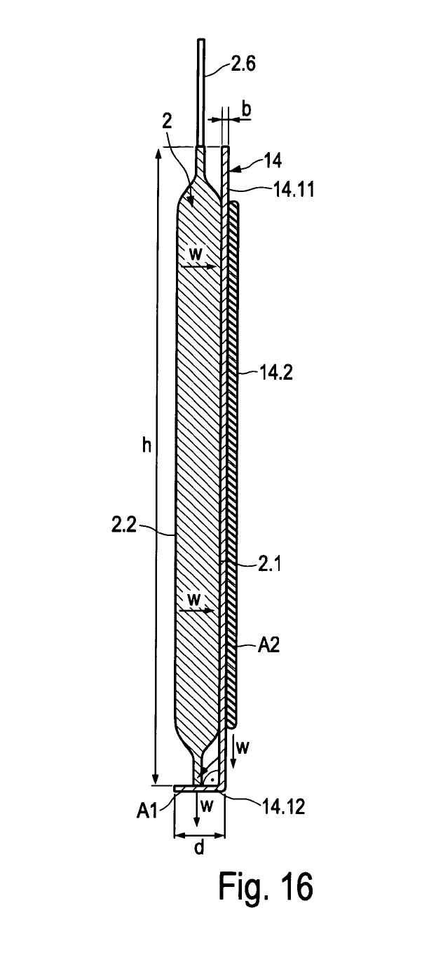

FIG. 16 a schematic cross-sectional view of an individual cell and a heat-conducting element,

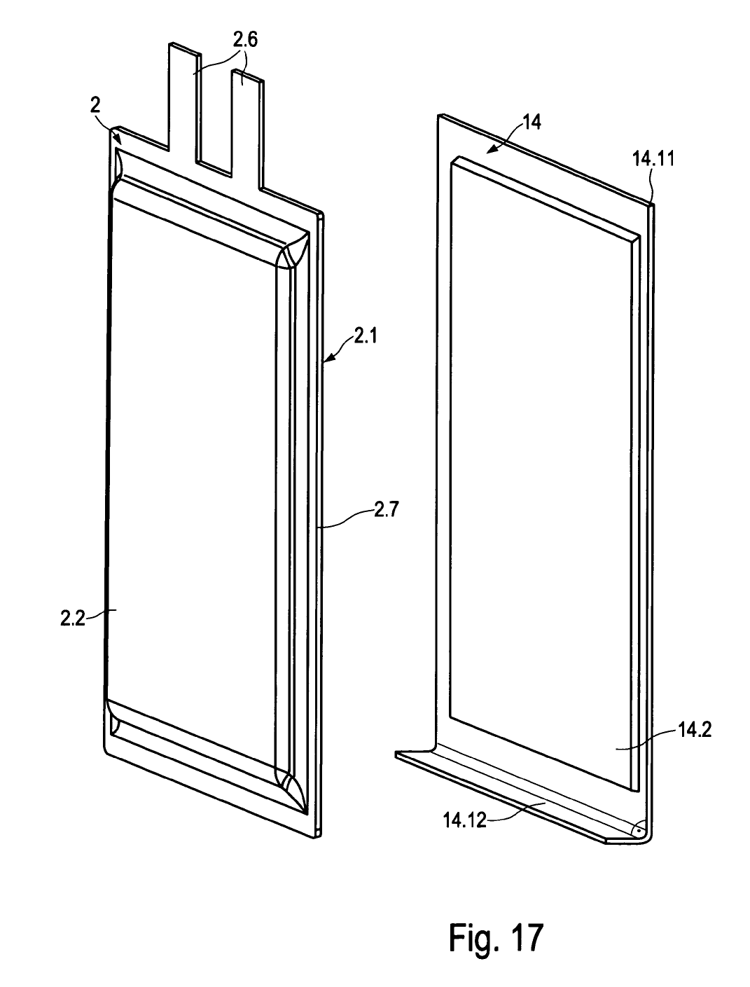

FIG. 17 an exploded schematic perspective view of an individual cell and a heat-conducting element,

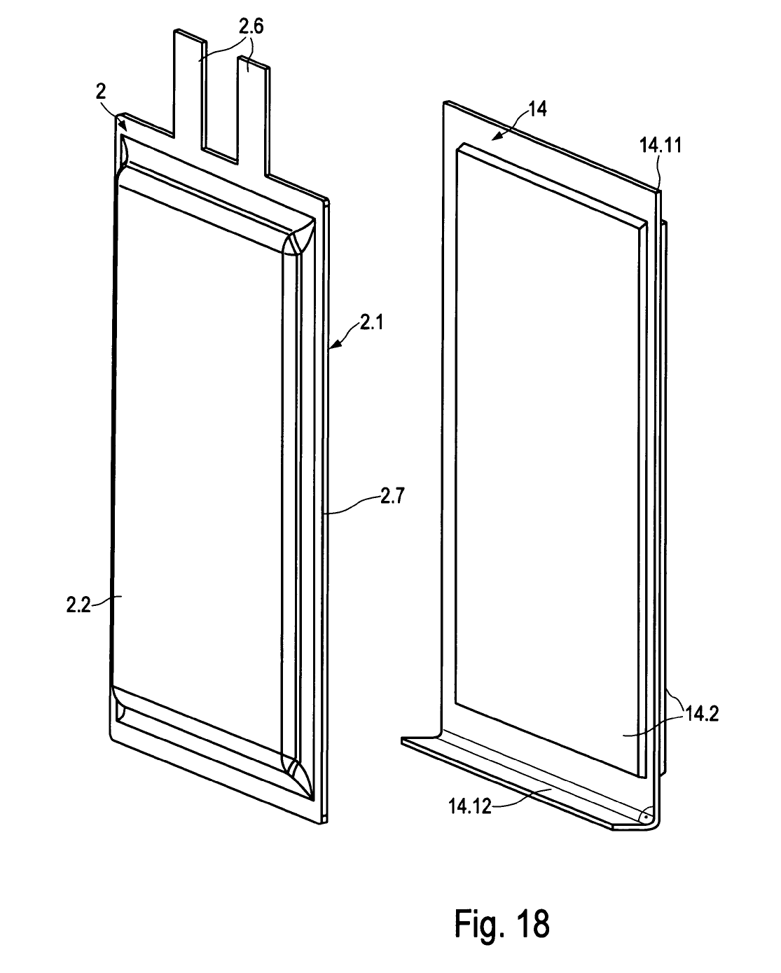

FIG. 18 an exploded schematic perspective view of an individual cell and a heat-conducting element,

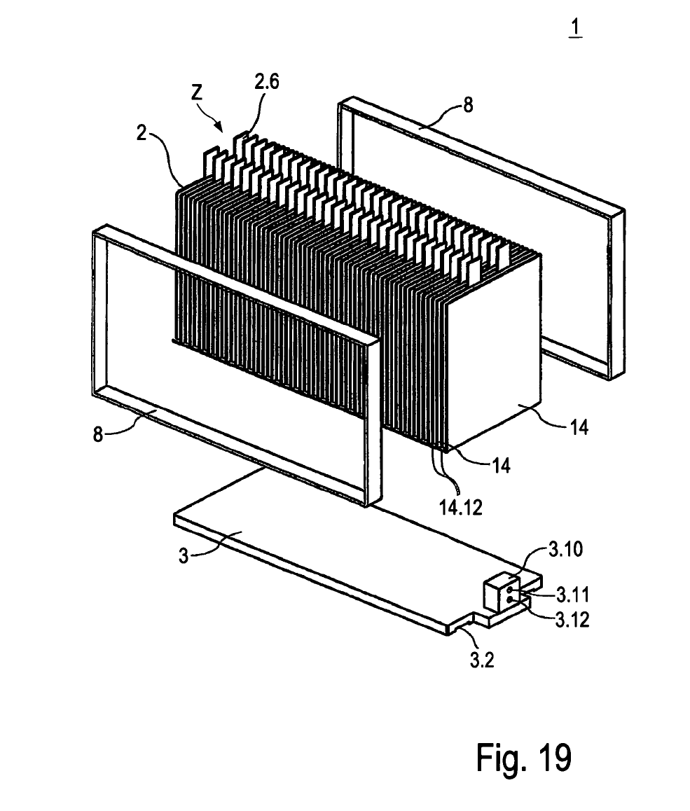

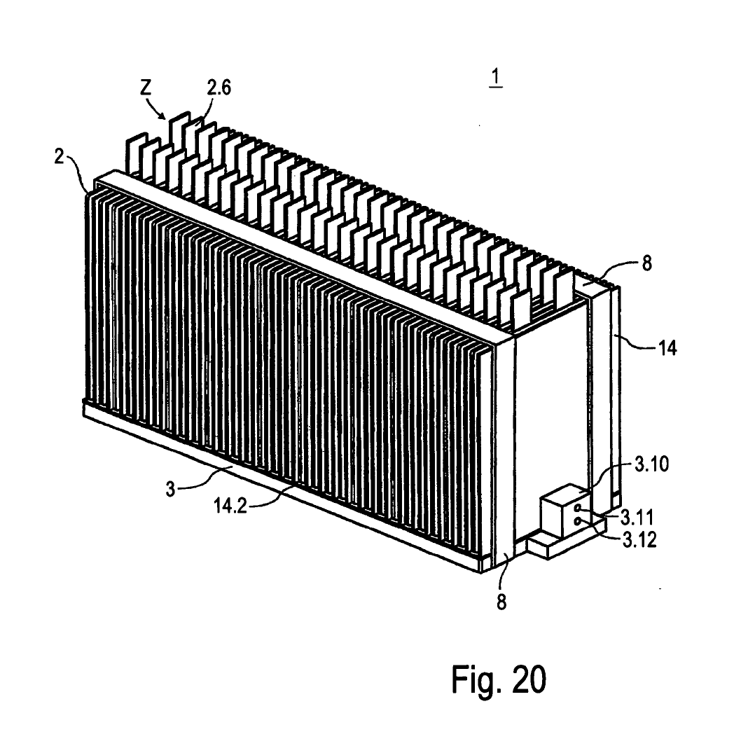

FIG. 19 an exploded schematic spatial view of a battery,

FIG. 20 a schematic spatial view of an assembled battery,

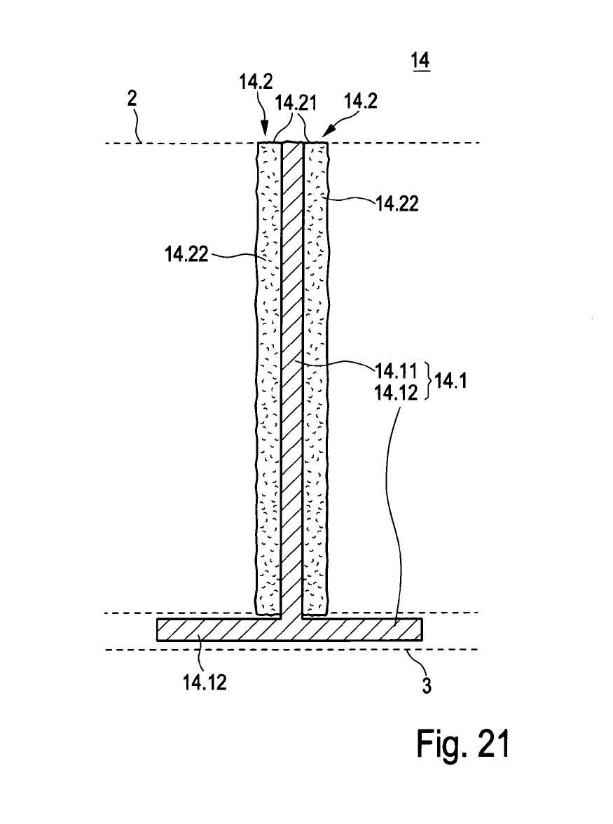

FIG. 21 a schematic cross-sectional view of a heat-conducting element,

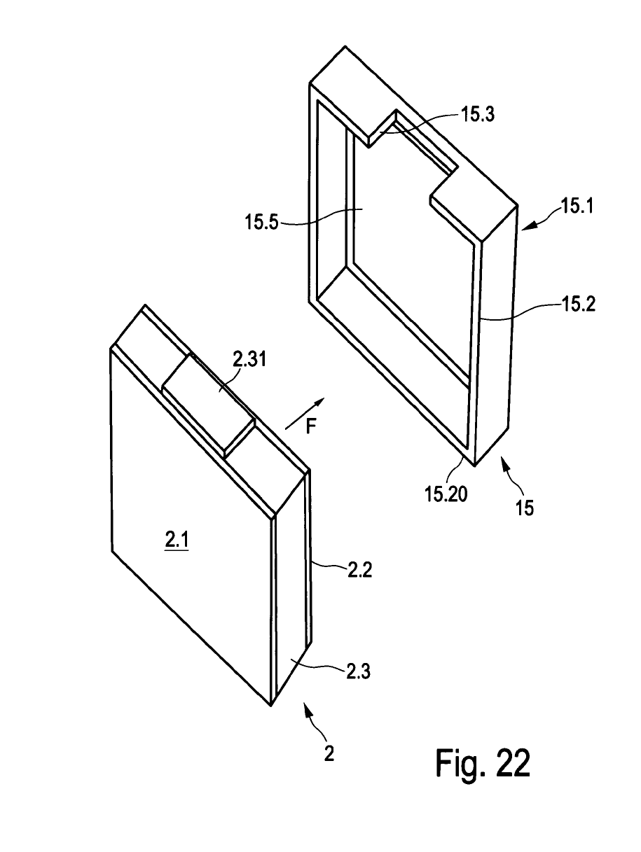

FIG. 22 a schematic spatial view of a heat-conducting element with flat-frame cell,

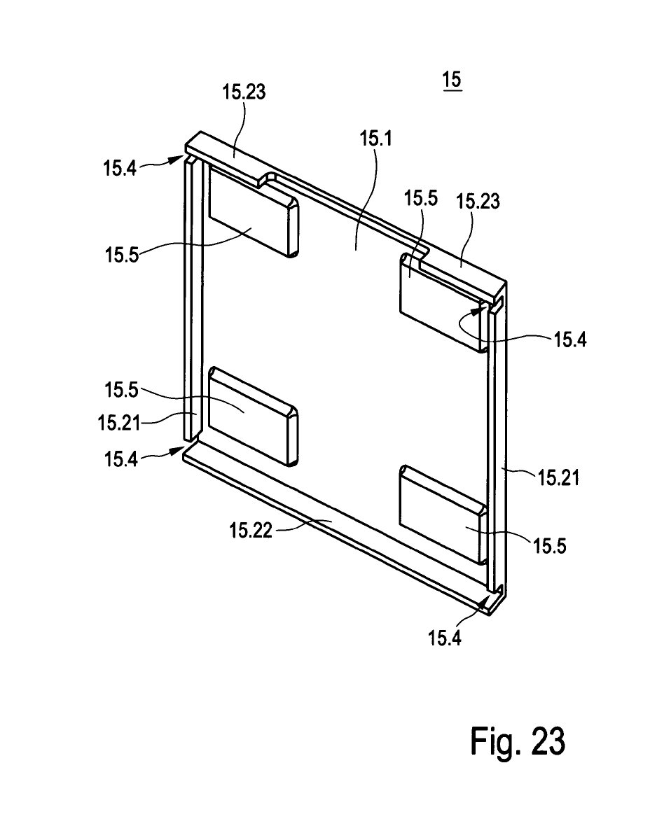

FIG. 23 a schematic spatial view of a similar heat-conducting element,

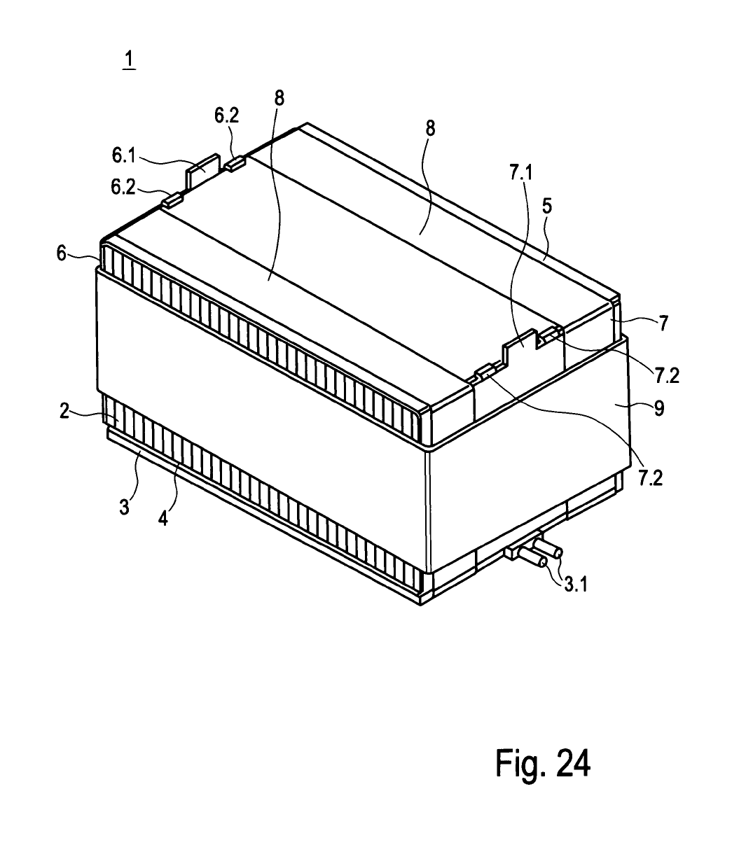

FIG. 24 a schematic spatial view of a battery comprising a plurality of flat-frame cells in a cell block clamped in three spatial directions,

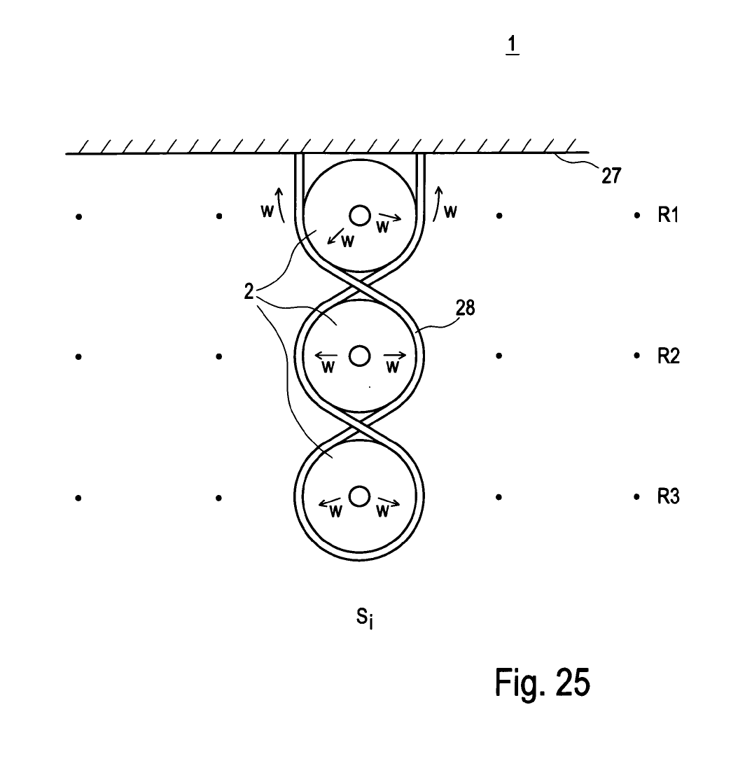

FIG. 25 a schematic plan view of a battery comprising several series of cylindrical battery cells braced to a battery housing wall by means of a tie strap,

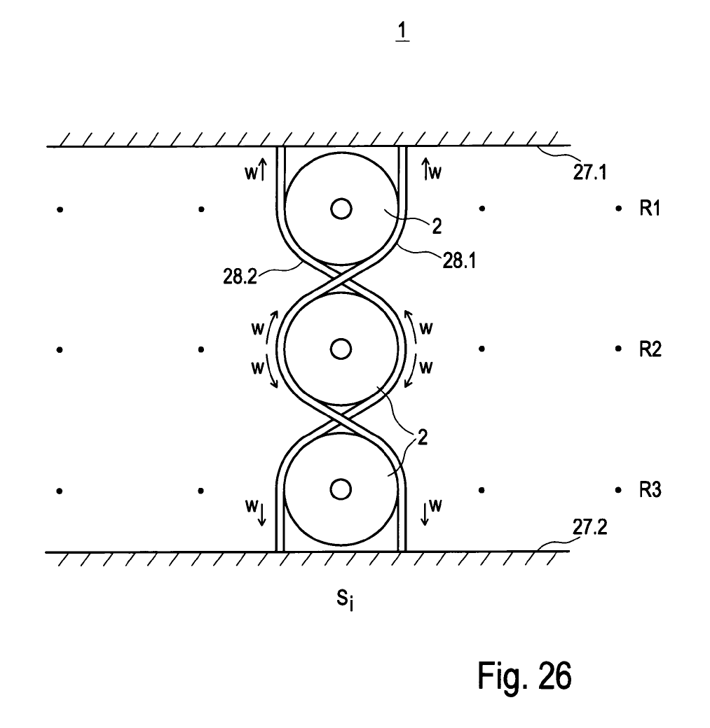

FIG. 26 a schematic plan view of a battery comprising several series of cylindrical battery cells braced to two battery housing walls by means of a tie strap.

It is to be noted that the figure illustrations are schematic and are at least substantially limited to depicting the features helpful in understanding the invention. It is also to be noted that the dimensions and scale ratios shown in the figures are essentially as such for the purpose of providing clarity to the depictions and are not necessarily to be understood as limiting unless noted otherwise in the description.

The same reference numerals are provided in all the figures to mutually corresponding components.

FIGS. 1 and 2 show a galvanic cell 2 (also referred to as individual cell 2 or cell 2) designed as a flat cell. The cell housing of individual cell 2 is thereby formed from two cell housing side walls 2.1, 2.2 and a cell housing frame 2.3 arranged peripherally around the edges between them.

The cell housing side walls 2.1, 2.2 of the individual cell 2 are electrically conductive and form poles P+, P− of the individual cell 2.

Two damping elements 2.4 are arranged on the cell housing side wall 2.1 of the negative pole P−. The damping elements 2.4 are designed with elastically resilient properties. The damping elements 2.4 are additionally electrically conductive and exhibit good heat conducting properties. The damping elements 2.4 are glued to the cell housing side wall 2.1, whereby the bond is realized to be thermoconducting or heat permeable respectively as well as electrically conductive.

The individual cell 2 comprises at least three voltage connection contacts K1 to K3. In detail, the cell housing side wall 2.1 forming the negative pole P− comprises at least two voltage connection contacts K1, K2 which are in particular connected electrically to each other within the cell, particularly connected in parallel. The first voltage connection contact K1 is thereby formed by the electrically conductive damping elements 2.4 affixed to pole P− of the individual cell 2, and thus cell housing side wall 2.1. The second voltage connection contact K2 is realized as measuring connection 2.11 which projects radially as a lug-like extension beyond the cell housing side wall 2.1 at any desired position above the individual cell 2, in the present case at the top of the cell 2.

The third voltage connection contact K3 is formed by the cell housing side wall 2.2 forming the pole P+.

The cell housing frame 2.3 is designed to be electrically insulating so that the cell housing side walls 2.1, 2.2 of different polarity are electrically insulated from each other. On an upper side, the cell housing frame 2.3 additionally comprises a partial material protuberance 2.31, the function of which will be described in greater detail in the description of FIGS. 4 and 5.

FIG. 2 shows the individual cell 2 according to FIG. 1 in a cross-sectional view, wherein an electrode stack 2.5 is arranged within the cell housing 2.

Electrode films 2.51 of different polarity, particularly aluminum and/or copper films or metal alloy films, are thereby stacked atop each other in a middle section and electrically insulated from one another by means of a separator (not more specifically detailed), particularly a separator film.

Electrode films 2.51 of like polarity are electrically interconnected in an edge section of the electrode films 2.51 overlaying the middle section of the electrode stack 2.5. The interconnected ends of the electrode films 2.51 of like polarity thus form a pole contact 2.52. The pole contacts 2.52 of different polarity of the individual cell 2.2 are also referred to as current conductor tabs 2.52 in the following. Specifically, the ends of the electrode films 2.51 are pressed and/or welded together in electrically conductive fashion and form the current conductor tabs 2.52 of the electrode stack 4.

The electrode stack 2.5 is arranged in the cell housing frame 2.3 disposed peripherally around said electrode stack 2.5. The cell housing frame 2.3 comprises for that purpose two material recesses 2.33, 2.34 at a distance from one another which are configured such that the current conductor tabs 2.52 of different polarity are disposed in the material recesses 2.33, 2.34. The clearance height h1 of the material recesses 2.33, 2.34 is designed so as to correspond to or be less than the extension of the prospective current conductor tabs 2.52 stacked atop one another. The depth t to the material recesses 2.33, 2.34 corresponds to or is configured to be greater than the extension of the current conductor tabs 2.52.

Since the cell housing frame 2.3 is preferably made from an electrically insulating material, the current conductor tabs 7 of different polarity are electrically insulated from each other such that additional arrangements for electrical insulation are unnecessary.

By the fixing of the cell housing side walls 2.1, 2.2 in a peripheral recess around the cell housing frame 2.3, which ensues for example in a manner not more specifically detailed by means of adhesive and/or beading of the flat sides 2.8, the current conductor tabs 2.52 of different polarity are pressed against the cell housing side walls 2.1, 2.2 such that a respective electric potential of the current conductor tabs 2.52 bears on the cell housing side walls 2.1, 2.2 and these form the poles P+, P− of the individual cell 2.

In a further development of the invention, a film not more specifically detailed which is for example made of nickel can additionally be arranged between the current conductor tabs 2.52, which for example are made from copper, and the housing side walls 2.1, 2.2, which for example are made from aluminum, so as to achieve an improved electrical connection between the current conductor tabs 2.52 and the cell housing side walls 2.1, 2.2.

It is furthermore possible in one embodiment of the invention for an electrically insulating film not further depicted to be arranged between the current conductor tabs 2.52 and the cell housing side walls 2.1, 2.2, or for the cell housing side walls 2.1, 2.2 to be realized with an electrically insulating layer on one side respectively, so that electrical contacting of the current conductor tabs 2.52 and the cell housing side walls 2.1, 2.2 does not occur until a not more specifically detailed through-penetration welding procedure as known from the prior art through the cell housing side walls 2.1, 2.2 from the outside.

In accordance with the depiction in FIG. 2, the damping elements 2.4 are arranged on the housing side wall 2.1 at approximately the same height as the current conductor tabs 2.52 and exhibit a height h2 measured outward from the housing side wall 2.1. That part of the flat side 2.8 of the cell 2, or the housing side wall 2.1 respectively, limiting the electrode stack 2.5 has no damping elements 2.4. When a plurality of individual cells 2 are being lined up and tensioned in the direction of a cell stack (stacking direction s) and a compressive force D is applied to the individual cell 2, the introduction of the compressive force D is limited to the current conductor tabs 2.52 and the adjoining regions of the cell housing frame 2.3 while the electrode stack 2.5 remains unsubjected to any compressive forces. This also remains as such should the electrode stack 2.5 expand in stacking direction s during operation of the individual cell 2.

FIG. 3 depicts an exploded view of the individual cell 2 illustrated in greater detail in FIGS. 1 and 2 and also shows the arrangement of the electrode stack 2.5 in the cell housing frame 2.3 as well as the cell housing side walls 2.1, 2.2.

A lower area of the cell housing side wall 2.1 with the lug-like measuring connection 2.11 is thereby bent 90° toward the cell housing frame 2.3 to form a folded edge 2.12 so that when a heat-conducting plate 4 as depicted in FIGS. 4 and 5 is used, enlargement of an effective heat transfer surface A1 and thus improved cooling of the battery 1 can be achieved.

In modifications of the present embodiment, the damping elements 2.4 are arranged on the other housing side wall 2.2 or on both housing side walls 2.1, 2.2. In the latter modification, a further embodiment variant can provide for one damping element 2.4 to be arranged in the upper region of the housing side wall 2.1 and a further damping element 2.4 in the lower area of the housing side wall 2.2 or vice versa. Such an arrangement can prevent, particularly in the absence of the measuring connection 2.11, an inadvertent reverse cell polarity as the position of the damping elements 2.4 codes the pole location.

In FIGS. 4 and 5, the battery 1, which for example is used in a vehicle, particularly a hybrid and/or electric vehicle, is depicted in an exploded and perspective view.

FIG. 4 shows an exploded view of a battery 1 having a cell assembly Z comprising a plurality of individual cells 2. To form the cell assembly Z, the poles P+, P− of a plurality of individual cells 2 are electrically connected in series and/or parallel as a function of the desired electrical voltage and output of the battery 1. Likewise subject to the desired electrical voltage and output of the battery 1, the cell assembly Z can be formed from any number of individual cells 2 in further developments of the invention.

By the respective cell housing side walls 2.1, 2.2 of adjacent individual cells 2 of different electrical polarity electrically contacting by means of the damping elements 2.4, a series electrical connection of the poles P+, P− of the individual cells 2 is realized. In particular, the cell housing side wall 2.2 of one of the individual cells 2 thereby bears against the damping elements 2.4 of an adjacent individual cell 2 affixed to the cell housing side wall 2.1 with the lug-like measuring connection 2.11 in force-fit, form-locking and/or in a material connection and is thereby, since the damping elements are electrically conductive, electrically connected to the adjacent individual cell 2.

The battery 1 in the depicted embodiment of the invention is formed from thirty individual cells 2 which are electrically interconnected in series. To withdraw and/or supply electrical energy from and/or into the battery 1, an electrical connector element 10 is arranged on the cell housing side wall 2.2 of the first individual cell E1 of the cell assembly Z which in particular forms the positive pole P+ of the first individual cell E1. This connector element 10 is configured as an electrical connection tab and forms the positive pole connection Pₚₒₛ of the battery 1.

An electrical connector element 11 is also arranged on the cell housing side wall 2.1 of the last individual cell E2 of the cell assembly Z which in particular forms the negative pole P− of the last individual cell E2. This connector element 11 is likewise configured as an electrical connection tab and forms the negative pole connection P_{neg} of the battery 1. It is noted that at least the upper damping element 2.4 of the last individual cell E2 is removed at this point.

The cell assembly Z is thermally coupled to the heat-conducting plate 3 at the bottom of the battery 1. The heat-conducting plate exhibits heat transfer medium connections 3.1 which are connected to heat transfer medium channels (not detailed more specifically) arranged within the interior of the heat-conducting plate 3, for example in sinuous and if needed branched form. The cell housing side walls 2.1 with the folded edge angled 90° toward the cell housing frame 2.3 are thereby thermally coupled to the heat-conducting plate 3 either directly or indirectly by means of a thermally conductive material, particularly a heat-conducting film 4, so as to achieve effective cooling of the battery 1.

In a further development of the invention, the thermally conductive material can be additionally or alternatively formed from a casting compound and/or a varnish.

For a force-fit connection of the individual cells 2 into a cell assembly Z and a force-fit joining of the heat-conducting plate 3 and the heat-conducting film 4 to the cell assembly Z, the cell assembly Z, the heat-conducting plate 3 and the heat-conducting film 4 are arranged in a housing frame. This housing frame is in particular formed from one or more clamping elements 8, e.g. tension bands, completely surrounding the cell assembly Z, which force-fit connect the individual cells 2 or the cell assembly Z respectively, the heat-conducting plate 3 and the heat-conducting film 4 both in the horizontal as well as also the vertical direction. In order to enable a secure hold of the clamping elements 8, material recesses 3.2 preferably corresponding to the dimensions of the clamping elements 8 are configured on a bottom side of the heat-conducting plate 3.

In a not depicted further development of the invention, some or all of the components; i.e. the individual cells 2, the heat-conducting plate 8, the heat-conducting film 11 or the entire battery 1 can be alternatively or additionally installed partially or completely encapsulated in a battery housing.

In this embodiment of the invention, the damping elements 2.4 are designed to be elastically resilient, electrically conductive and thermoconducting. The housing side walls 2.1 and 2.2 which form the poles P− and P+ of the cells 2 are thus reliably electrically contactable between neighboring cells by way of the damping elements 2.4. A compressive force which is introduced into the cell block Z by way of the tension bands 8 is further introduced into the frame area of the cells 2 by way of the damping elements 2.4, whereby the area of the electrode stack 2.5 remains unsubjected to compressive forces. The cell 2, in particular the electrode stack 2.5, can expand comparatively freely in the stacking direction during operation. The damping elements 2.4 can also absorb vibrations, whereby the individual cells 2 are to a large extent mechanically decoupled from one another. Lastly, the damping elements 2.4 have good heat-conducting properties. A heat exchange between adjacent individual cells 2 can thereby occur. Excess heat from one individual cell 2 can not only be dissipated via the cell housing side wall 2.1 of said individual cell 2 but additionally via the cell housing side wall 2.1 of a neighboring individual cell 2.

If the battery 1 is for example a lithium ion high-voltage battery, a special electronics which e.g. monitors and adjusts a cell voltage of the individual cells 2, a battery management system which in particular controls a power draw/output of the battery 1 (=battery control), and fuse elements which realize the safe disconnecting of the battery 1 from an electrical power supply upon malfunctions are generally needed.

In the depicted embodiment of the invention, an electronic component 13 is provided which at least contains not further depicted devices for monitoring and/or equalizing cell voltage. The electronic component 13 can also be configured in a further development of the invention as an encapsulated electronic structural unit.

The electronic component 13 is arranged on the clamping elements 12 and the cell housing frame 2.3 of the individual cells 2 on the head side of the cell assembly. In order to achieve the largest possible contact surface for the electronic component 13 and at the same time a fixing of the clamping elements 8 at the top of the cell assembly Z, the material protuberance 2.31 is formed at part of the top of the frame 2.3 of each individual cell 2, the height of which corresponds in particular to the thickness of the clamping elements 8. Not further depicted force-fitting, form-fitting and/or materially connecting joining techniques are used to mount the electronic component 13 to the cell assembly Z and/or to the clamping elements 8.

For an electrical contact of the cell assembly Z to the electronic component 13, the lug-like measuring connections 2.11 arranged on the cell housing side walls 2.1 are led through contact elements 13.3 arranged in the electronic component 13 which exhibit a form corresponding to the lug-like measuring connections 2.11.

Additionally, further electronic components (not further depicted) are also provided which contain for example the battery management system, the battery control, the fuse elements and/or further devices for operating and controlling the battery 1.

FIG. 6 shows a schematic cross-sectional view of a configuration of a damping element 2.4 as depicted in FIG. 1, 2 or 3 in a first preferential design variant.

In accordance with the FIG. 6 depiction, the damping element 2.4 comprises a first shell 2.41 and a second shell 2.42. The shells 2.41, 2.42 are connected together at a seam 2.43, for example by welding, gluing or the like. The shells 2.41, 2.42 are made from an electrically conductive and thermoconducting material such as for instance aluminum or the like. The shells 2.41, 2.42 enclose an interior space 2.44 which in the depicted design variant is filled with an insulating material such as for instance a PU foam, foam rubber, felt or the like. It is also conceivable in a further design variant for the interior space 2.44 to be filled only with air.

FIG. 7 shows a schematic cross-sectional view of a configuration of a damping element 2.4 as depicted in FIG. 1, 2 or 3 in a further preferential design variant.

In accordance with the FIG. 7 depiction, the damping element 2.4 comprises a first shell 2.41 and a second shell 2.42. A bellows structure 2.45 extends along the edges between the shells 2.41, 2.42 and is connected to the shells 2.41, 2.42 at seams 2.43. The shells 2.41, 2.42 are made from an electrically conductive and thermoconducting material such as for instance aluminum or the like. The shells 2.41, 2.42 enclose an interior space 2.44 which in the depicted design variant is filled with an insulating material such as for instance a PU foam, foam rubber, felt or the like. Given the appropriate rigidity to the bellows structure 2.45, it is also conceivable in a further design variant for the interior space 2.44 to be filled only with air.

FIG. 8 shows a schematic cross-sectional view of a configuration of a damping element 2.4 as depicted in FIG. 1, 2 or 3 in a further preferential design variant.

In accordance with the FIG. 8 depiction, the damping element 2.4 comprises a foam block 2.41. The foam block 2.41 comprises a thermally conductive and electrically conductive plastic. In a further design variant, the foam block 2.45 is foamed from an electrically and thermally insulating material doped with filler material which is a good electrical and thermal conductor.

It is again pointed out particularly, but not solely, with respect to FIGS. 6 to 8, that the ratios of component dimensions such as for instance component thickness and/or component size can be distorted in the figures for the purposes of clarifying the representation and can deviate, sometimes considerably, from the actual realizations.

FIG. 9 illustrates in an exploded schematic spatial view an individual cell 2 designed as a flat cell as a further embodiment of the present invention. This embodiment is a modification of the embodiment depicted in FIGS. 1 to 5; provided nothing different is stipulated in the following clarification, the comments made with respect to FIGS. 1 to 5 are to apply accordingly.

In accordance with the FIG. 9 depiction, a cell housing (an enclosure) of the cell 2 is formed by two cell housing side walls 2.1, 2.2 and a cell housing frame 2.3 arranged peripherally around the edges between them. The cell housing side walls 2.1, 2.2 of the cell 2 are of electrically conductive design and form poles P+, P− of the cell 2. The cell housing frame 2.3 is designed to be electrically insulating so that the cell housing side walls 2.1, 2.2 of different polarity are electrically insulated from one another. On an upper side, the cell housing frame 2.3 additionally comprises a partial material protuberance 2.31.

As in the previous embodiment of the invention, the cell housing side wall 2.1 with the lug-like measuring connection 2.11 also exhibits a folded edge 2.12 angled 90° toward the cell housing frame 2.3 in a bottom region here as well. Said cell housing side wall 2.1 further exhibits in an upper region two tabs 2.13 angled 90° toward the cell housing frame 2.3. When assembled, the tabs 2.13 grip the upper narrow side 2.32 of the cell housing frame 2.3 alongside the material protuberance 2.31 while edge 2.12 grips the lower narrow side of the cell housing frame 2.3.

In the present embodiment, the cell housing side wall 2.2 serving as the positive pole P+ comprises a damping element 2.4 elevated from the cell housing side wall 2.2. The damping element 2.4 here thus forms the third voltage connection contact K3 of the cell 2 while the other cell housing side wall 2.1 forms the first voltage connection contact K1. As to the properties of the damping element 2.4, reference is made to the clarifications of the previous embodiment and its modifications. In the present embodiment, the damping element 2.4 extends over the entire surface of the cell housing side wall 2.2 to a small edge area which enables compressive forces to be distributed over the entire surface of the cell housing side walls 21, 22 of the cell 2. In embodiment variants, the damping element 2.4 can be configured only over sections on the cell housing side wall 2.2.

FIG. 10 illustrates a modification of the cell 2 depicted in FIG. 9 in an exploded schematic spatial view.

The cell housing side wall 2.1 with the lug-like measuring connection 2.11 exhibits a lower edge (folded edge) 2.12 angled 90° toward the cell housing frame 2.3 in a bottom region. In the present modification, the other cell housing side wall 2.2 exhibits two tabs 2.22 angled 90° toward the cell housing frame 2.3 in an upper region. When assembled, the tabs 2.22 of the second housing side wall 2.2 grip the upper narrow side 2.32 of the cell housing frame 2.3 alongside the material protuberance 2.31 while edge 2.12 of the first housing side wall 2.1 grips the lower narrow side of the cell housing frame 2.3.

In accordance with the FIG. 10 depiction, the second cell housing wall 2.2 exhibits a damping element 2.4 and the first cell housing wall 2.1 additionally exhibits a damping element 2.4. Both damping elements 2.4 are configured as the damping element 2.4 shown in the embodiment depicted in FIG. 8 and form the first and the third voltage connection contact K1, K3 of the cell 2.

A structuring of the cell 2 according to FIG. 9 or FIG. 10 is of advantage in the case of a battery described as a modification to the battery 1 depicted in FIGS. 4 and 5. The tension bands 8 are thereby made from a thermally conductive material such as for instance metal and bear flatly against the upper narrow sides 2.32 of the cells 2 and thus the tabs 2.13 of the shell housing side wall 2.1. A transfer of heat between the tabs 2.13 of the cell housing side wall 2.1 and the tension bands 8 can thus take place and the excess heat can be conveyed through the tension bands 8 to the cooling plate 3 as needed.

An electrically insulating yet thermally conductive or heat permeable coating of the tension bands, or a corresponding interlayer between the tension bands 8 and the (not shown) tabs 2.13 of cell housing side wall 2.1 respectively, prevents a short-circuiting or an unwanted contact between adjacent cells 2.

To enlarge the heat transfer surface, the width of the tension bands 8 can be enlarged compared to the battery 1 shown in FIGS. 4 and 5 and the width of the material protuberance 2.31 of the cell housing frame 2.3 accordingly reduced.

An electrical intercontacting of the cells 2 ensues in this embodiment via the damping element 2.4. The damping element 2.4 facilitates a heat exchange between neighboring cells 2 as well as a dissipation of the heat generated within the interior of the cells 2.

FIG. 11 illustrates the structure of such a battery 1 as a further embodiment of the invention in an schematic spatial view. The battery 1 in this embodiment can be understood as a modification of the battery shown in FIGS. 4 and 5 such that reference is made to the relevant clarifications provided with respect to the basic structure.

The battery 1 is composed of thirty-five individual cells 2. The individual cells 2 are secondary cells (accumulator cells) having active areas containing lithium and are configured as flat-cell frames in accordance with FIG. 9 or FIG. 10.

A cooling plate 3 for controlling the temperature of the cells 2 is arranged under the cells 2. The cooling plate 3 comprises a cooling channel (not more specifically detailed) in its interior through which a coolant can flow as well as two coolant connections 3.1 to supply and extract the coolant. The coolant connections 3.1 can connect the cooling plate 3 to a not shown coolant circuit through which the heat absorbed by the coolant can be discharged from the battery 1.

A heat-conducting film 4 of electrically insulating material which electrically insulates the cooling plate 3 from the cells 2 is disposed between the cooling plate 3 and the bottom areas of the cells 2 or the lower folded edges 2.12 of the cell housing side walls 2.1 respectively. A pressure plate 5 made from a metal such as for instance steel, aluminum or the like is arranged above the cells 2, whereby an electrically insulating coating (not shown) is provided on the underside. Further alternatively, the pressure plate 5 can be made of an electrically insulating material which has good heat-conducting properties such as for instance a reinforced plastic with thermoconducting dopings.

A front pole plate 6 is disposed at a front end of the cell assembly and a rear pole plate 7 disposed at a rear end of the cell assembly. The pole plates 6 and 7 respectively form a pole of the battery 1 and each exhibit a tab-like extension 6.1, 7.1 projecting over the pressure plate 5, each forming a pole contact of the battery 1. Each of the pole plates 6 and 7 further comprises two fastening tabs (see 6.2, 7.2 in FIG. 3) angled parallel to the pressure plate 5 from the respective pole plate 6, 7, bearing on the pressure plate 5 and electrically insulated from the pressure plate 5.

The pressure plate 5, the cells 2, the pole plates 6, 7 and the cooling plate 3 are pressed together by two tension bands 8, each guided around the pressure plate 5, the pole plates 6, 7 and the cooling plate 3. The tension bands 8 span vertical planes relative to the battery 1 and are therefore also referred to as vertical tension bands 8.

The tension bands 8 are formed from a good heat conductor such as for instance spring steel and have an electrically insulating yet thermally conductive and/or heat permeable coating. Alternatively, an electrically insulating interlayer similar to the heat-conducting film 4 can be disposed between the pressure plate 5 and the cells 2. The vertical tension bands 8 have thermally conductive contact to the pressure plate 5 and the cooling plate 3.

Due to the thermoconducting properties of the vertical tension bands 8 and the pressure plate 5 and the thermally conductive contact of the pressure plate 5 between the upper narrow sides of the absorbing heat-conducting elements 16 of the cells 2 and the vertical tension bands 8, an equalizing of heat can also ensue between the cells 2 in the upper area of the battery as well as a heat transfer from the top to the cooling plate 3 disposed at the bottom.

In one design variant, the pressure plate 5 is at least partially designed as a conductor plate of an electrically insulating carrier material, preferably as plastic with optional glass fiber reinforcing, and supports electrical components for the monitoring and/or control of battery functions as well as conductor paths, neither being depicted. Such electrical components are for example cell voltage monitoring elements and/or cell voltage equalizing elements for equalizing different states of cell charges, which are provided for example on the conductor plate in the form of microchips, and/or temperature sensors for monitoring a temperature of the cells 2. At least in areas on which the tension bands 8 lie, the pressure plate 5 has good heat-conducting properties; such zones can also be termed heat conduction zones. The pressure plate 5 is thereby preferably further configured such that heat generating and/or heat-sensitive circuit elements can be arranged in proximity to the heat conduction zone and/or in thermoconducting contact with the heat conduction zone. It is particularly preferable for the conductor plate itself to have good heat-conducting properties and form as such the pressure plate 5. In a further design variant, the pressure plate 5 can be completely formed from a material with good heat-conducting properties, wherein a conductor plate as described above is provided in those areas where there is no tension band 8.

In the present invention, the clamping device is realized by two metallic tension bands 8 provided with an electrically insulating yet thermally conductive coating. Alternatively to a coating, electrically insulating yet thermally conductive or heat permeable interlayers such as for instance the heat-conducting film 4 can also be provided, also between the vertical tension bands 8 and the pole plates 6, 7.

In one design variant, the tension bands 8 can be made from a non-conductive material, for instance a thermoconducting plastic, preferably with glass fiber, Kevlar or metal reinforcing, and a thermoconducting filler material. In such a case, additional insulating may be unnecessary.

In the present embodiment, the tension bands 8 each exhibit a clamping area which in the depicted design variant is depicted as a wave-like expansion area. Instead of an expansion area of the tension bands 8, a crimping process can also be used to clamp the tension bands and to permanently interconnect the ends. In a further design variant, toggle closures, screw couplings or a similar type of turnbuckle can be provided.

In one design variant, the tension bands 8 extend across the pressure plate 5, the rear pole plate 7, the cooling plate 3 and the front pole plate 6 within recesses not more specifically detailed.

FIG. 12 illustrates the structure of a battery cell 2 as a further embodiment of the present invention in a schematic spatial view.

The battery cell 2 of this embodiment is a so-called coffee bag or pouch cell, its flat approximately cuboid electrode stack (active part) being wrapped within a film which is sealed in the edge region and forms a so-called sealed seam 2.7. Current conductors 2.6 of the cell 2 extend through the sealed seam 2.7 at passage areas 2.71. The current conductors 2.6 of the cell 2 are in this embodiment arranged on opposite narrow sides, preferably the shorter narrow sides of the cell 2. A beading 2.72 is formed on the other narrow sides of the sealed seam 2.7.

Damping elements 2.4 are affixed, e.g. glued, etc., to the flat sides of the cell 2 as elastic means (pads). The damping elements 2.4 serve on elastically supporting the cell 2 relative to other cells or a battery housing frame as a frame element and are suited to equalizing thermal expansions or cushioning impacts. The damping elements 2.4 have good heat-conducting properties but are not electrically conductive. To that end, for example a flexible, intrinsically not particularly heat-conductive material such as for instance PU foam, foam rubber or the like is disposed in a casing (film or the like) which is a good thermal conductor. The casing is of preferably self-expandable or bellows-like design so as to be able to move in unison with the movements of the flexible material.

In one modification, the flexible material itself which can be, but is not mandatory to be, arranged in a separate casing has heat-conducting properties. This can for example be a heat-conducting gel, an arrangement of metal springs or fillings or the like or a foam doped with metal objects.

In all other respects regarding the damping elements 2.4, the details provided based on FIGS. 6 to 8 can be drawn on analogously.

The thermoconducting properties of the damping elements 2.4 can facilitate thermal equalization between adjacent cells 2. Should heat-conducting means such as for instance heat-conducting plates or the like be arranged between adjacent cells 2, an effective dissipation of heat from a cell assembly of cells 2 can also be realized without active cooling needing to be provided inside the cell assembly.

FIG. 13 illustrates a battery 1 with a plurality of cells 2 in accordance with FIG. 12 as a further embodiment of the present invention in a spatial view.

In accordance with the FIG. 13 depiction, a plurality of cells 2 are arranged between two respective retaining frames 16, 16 or 16, 17. The arrangement of cells 2 and retaining frames 16, 17 is disposed between two end plates 18, 19. Four tension bars 20 with locknuts 21 are provided to clamp the assembly of cells, retaining frames 16, 17 and end plates 18, 19.

The end plates 18, 19 serve also as electrical poles of the battery 1. Corresponding connection devices 23, 24 are provided for the connection. A controller 26 affixed to a strut 25 is provided for monitoring status parameters of the battery 1 and the individual cells 2, for charge equalizing and the like. To prevent a short circuit between the end plates 18, 19, the tension bars 20 and/or locknuts 21 are electrically insulated from at least one of said end plates 18, 19.

The cells 2 are designed in the present embodiment as so-called coffee bag or pouch cells in accordance with FIG. 12. The retaining frames 16, 17 grip the cells 2 by the connectors themselves or the passage areas 2.71 and heat is released at this point to the frame elements 16, 17. Heat-conducting films (not more specifically detailed) are further arranged between the damping elements 2.4 of a cell 2 and a bare flat side 2.8 of a neighboring cell 2 which extends upward and downward in the area of the beading 2.72 of the sealed seam 2.7 and is clamped there between the beading 2.72 and a respective retaining frame 16, 17. By so doing, heat from the cell interior can also be released to the frame elements 16, 17 via the flat sides 2.8, the damping elements 2.4 and the not further depicted heat-conducting films. The heat can be dissipated from the frame elements 16, 17 forming a compact block by convection or heat sink such as for example a cooling plate, for example as shown in FIG. 5 et al.

In one design variant, the tension bars 20 absorb heat from the frame elements 16, 17 so as to discharge it to the outside. To this end, they are in thermoconducting contact with the end plates 18, 19. Via the end plates 18, 19 the heat can then be dissipated by means of a suitable cooling device (not more specifically detailed). The tension bars extend through the frame elements 16, 17 and absorb heat from the retaining frames 16, 17. Alternatively, separate contact elements can be provided which are gripped by the retaining frames 16, 17 and exert contact pressure on the edge sections of the cells 2 and absorb the heat from same. Conceivable as a cooling device is for example an aluminum or other good heat conductor profile through which air flows which is bolted to the end plates 18, 19 on the head end and/or the nut end by the tension bar. Alternatively, a cooling plate with or without circulating heat transfer medium can be frontally attached to one or both of the end plates 18, 19 at which the tension bar 20 can release heat. Other types of heat dissipation via tension bar 20 are also conceivable.

In further design variants, more than four tension bars, e.g. six or eight tension bars, can be provided to brace the cell block and discharge heat.

Alternatively, the bracing can for example also ensue with this form of a cell block by means of thermoconducting tension bands (see FIG. 11). In a further design variant, such tension bands can for example, but not restrictively, be guided over folded edges 16.1, 17.1, 18.1, 19.1 of the retaining frames 16, 17 and the end plates 18, 19.

FIGS. 14 and 15 depict a galvanic cell or battery cell (individual cell) 2 respectively configured as a flat cell and a heat-conducting element 14 corresponding thereto, whereby FIG. 14 shows a perspective view and FIG. 15 shows a cross-sectional view of the individual cell 2 and the heat-conducting element 14.

The individual cell 2 comprises a not further shown enclosure enclosing an electrode stack not more specifically detailed here. The enclosure comprises two film layers which are welded in an edge region in order to form a so-called sealed seam 2.7 so as to enclose the electrode stack in gas-tight and moisture-proof manner. The electrode stack takes shape as a thickening of the individual cell 2. The subsequent part of the enclosure on the flat sides of the electrode stack in a stacking direction s can also be understood as housing side walls 2.1, 2.2 in the sense of the FIG. 1 et seq. definition.

The electrode stack is configured similar to the electrode stack 2.5 depicted in FIG. 2; although conductor tabs, each laterally offset according to polarity, project from only one narrow side of the electrode stack (here the top) and are connected to current conductors 2.6 within the enclosure which extend outward through the sealed seam 2.7 and form the pole contacts P+, P− of the cell 2. In one design variant, polarity-combined conductor tabs of the electrode stack themselves can be guided outwardly through the sealed seam 2.7 as current conductors 2.6.

A damping element 2.4 is arranged on one of the housing side walls, here housing side wall 2.2. The damping element 2.4 is formed integrally with the housing side wall 2.2 in this embodiment. Specifically, the housing side wall exhibits an inner shell 2.2a and an outer shell 2.2b which are for example formed from a film material and can be understood analogously to the shells 2.41, 2.42 of the damping element 2.4 pursuant FIG. 6. A cavity 2.44 extends between the inner shell 2.2a and the outer shell 2.2b which is filled with an elastically flexible and thermally conductive material; reference is made to the remarks on FIG. 6 for conceivable design variants. In contrast to the damping element 2.4 shown in FIG. 6, it is to be pointed out that in the present embodiment, the outer shell 2.2b is not electrically conductive and that the filler material of the cavity 2.44 is thermoconducting.

The heat-conducting element 14 in the present embodiment is configured as a heat-conducting plate of width w and height h comprising a long limb 14.11 and a short limb 14.12, wherein the short limb 14.12 is angled at approximately 90° to the long limb 14.11 in a L-shape and has a length d. The underside of the short limb 14.12 forms a coolant contact surface A1 which can be cooled in the manner described below.

The long limb 14.11 of the heat-conducting element 14 has a thickness b and exhibits a cell contact surface A2 which bears against the first housing side wall 2.1 of the individual cell 2. A heat flow W from the individual cell 2 can thus be guided to the long limb 14.11 of the heat-conducting element 14 over a large surface area via the cell contact surface A2 and from there to its short limb 14.12 and dissipated via the short limb 14.12 through its cooling contact surface A1. At the same time, heat can be dissipated in a further thermal flow not more specifically detailed in a stacking arrangement of a plurality of cells 2 and heat-conducting elements 14 from the interior of the cell 2 to the long limb 14.12 of a heat-conducting element 14 via the heat-conducting damping element 2.4, dissipating via the short limb 14.12 through its cooling contact surface A1.

In a representation corresponding to FIG. 15, FIG. 16 shows a cross-sectional view of an individual cell 2 and a heat-conducting element 14 according to a further embodiment of the invention.

The individual cell 2 is configured similar to the individual cell in FIGS. 14 and 15. The individual cell 2 of the present embodiment lacks however a damping element (2.4 in FIG. 14/2.2a, 2.2b, 2.44 in FIG. 15). Instead, the heat-conducting element 14 exhibits a damping element 14.2 on a side of the long limb 14.11 opposite the individual cell 2.

The damping element 14.2 has good heating conducting properties. To that end, for example a flexible, intrinsically not particularly heat-conductive material such as for instance PU foam, foam rubber or the like is disposed in a casing (film or the like) which is a good thermal conductor. The casing is of preferably self-expandable or bellows-like design so as to be able to move in unison with the movements of the flexible material.

In one modification, the flexible material itself which can be, but is not mandatory to be, arranged in a separate casing has heat-conducting properties. This can for example be a heat-conducting gel, an arrangement of metal springs or fillings or the like or a foam doped with metal objects.

In a further modification, the damping element 14.2 can be applied directly to the long limb 14.11 as a thermally conductive damping layer.

The thermoconducting properties of the damping elements 2.4 can facilitate thermal equalization between adjacent cells 2 and realize an effective dissipation of heat from a cell assembly of cells 2 without active cooling needing to be provided inside the cell assembly.

FIG. 17 shows an individual cell 2 and a heat-conducting element 14 according to a further embodiment of the invention in an exploded spatial view.

The individual cell 2 is configured like the individual cell in FIG. 16. The heat-conducting element 14 is likewise configured substantially like the heat-conducting element 14 in FIG. 16; although the heat-conducting element 14 in the present embodiment comprises a damping element 14.2 on a side of the long limb 14.11 facing the individual cell 2. Reference is made to the clarifications provided on FIG. 21 as to the details of the damping element 14.2.

In a depiction corresponding to that of FIG. 17, FIG. 18 shows an individual cell 2 and a heat-conducting element 14 according to a further embodiment of the invention in an exploded spatial view.

The individual cell 2 is configured like the individual cell in FIG. 17. The heat-conducting element 14 is likewise configured substantially like the heat-conducting element 14 in FIG. 16 or 17; although the heat-conducting element 14 in the present embodiment comprises a damping element 14.2 on both sides of the long limb 14.11. Reference is made to the clarifications provided on FIG. 21 as to the details of the damping element 14.2.

FIGS. 19 and 20 show a battery 1 having a plurality of individual cells 2 described pursuant to FIGS. 14 to 18 and heat-conducting elements 14 arranged therebetween, wherein the battery 1 is shown in an exploded view in FIG. 19 and in assembled state in FIG. 20. The individual cells 2 are combined into a cell assembly Z.

To cool the battery 1, a cooling plate 3 is arranged at the bottom of the individual cells 2. The short limbs 14.12 of the heat-conducting elements 14 are thereby connected to the cooling plate 3 in thermally conductive manner, namely by flat contact. Heat transferred from the individual cells 2 to the associated heat-conducting elements 14 is thereby discharged to the cooling plate 3 when the temperature is lower than the temperature of the heat-conducting elements 14.

The heat-conducting elements 14 are pressed to the individual cells 2 and fixed to the cooling plate 3 by means of clamping elements 8, particularly tension belts. To this end, the cooling plate 3 exhibits longitudinal notchings 3.2 on a side opposite from the cell assembly Z which correspond to the dimensions of the clamping element 8, particularly its width and height. The number of notchings 3.2 corresponds in particular to the number of clamping elements 8 used to fix the cell assembly Z.

The cooling plate 3 further exhibits a coolant connector unit 3.10 comprising at least one inlet opening 3.11 and at least one outlet opening 3.12 through which a coolant or heat transfer medium respectively can be supplied to or extracted respectively from the cooling plate 3. The cooling plate 3 can be connected to a coolant circuit by means of the coolant connector unit 3.10, for example a coolant circuit of a not-shown air conditioning system of a motor vehicle. The coolant which dissipates the heat absorbed over the coolant circuit flows within said coolant circuit.

FIG. 21 illustrates the structure of a heat-conducting element 14 as a further embodiment of the present invention in a cross-sectional view.

The heat-conducting element 14 of this embodiment comprises a carrier structure 14.1 and two damping elements 14.2. The carrier structure 14.1 is made from a material which is a good conductor of heat such as for instance aluminum or another metal or a thermoconducting plastic, etc. It exhibits the form of a T-profile with a long limb 14.11 and two short limbs 14.12 in cross section. The long limb 14.11 is provided to be arranged between battery cells 2 (depicted as dotted outlines 2) of a cell assembly in order to absorb heat generated in the battery cells 2.

The short limbs 14.12 are provided to bear on a heat-conducting plate 3 (depicted as dotted outline 3) or the like in order to discharge heat absorbed from the battery cells 2. The damping elements 14.2 are arranged on both sides of the long limb 14.11, e.g. glued, etc. The damping elements 14.2 serve in elastically supporting the cells 2 relative each other and are suited to equalizing thermal expansions of the cells 2 or cushioning impacts. Reference is made in all other respects with regard to the properties of the damping elements 14.2 to the clarifications provided on the damping element 14.2 in the heat-conducting element 14 according to FIG. 16.

In one modification, the damping elements 14.22 can extend to the short limbs 14.12 so as to also achieve a downward cushioning particularly with flat-cell frames.

An electrically insulating heat-conducting foil or the like can be provided between the short limbs 14.22 and the cooling plate 3.

The heat-conducting element 14 of the present embodiment can be used in a battery 1 as depicted in FIGS. 4 and 5 between cells 2 which themselves do not comprise spring elements.

Both the damping elements 14.2 as well as also the carrier structure 14.1 are of electrically conductive design for use with cells having flat sides designed as cell poles. At least one damping element 14.2 can be of electrically insulating design at points within a battery at which a series connection of such cells is to be interrupted as well as for use with cells having cell poles of different configuration, for instance tab-like conductors.

FIG. 22 illustrates in a spatial view a heat-conducting element 15 having a galvanic cell (individual cell) 2 configured as a flat-cell frame as a further embodiment of the present invention, wherein the flat-cell frame 2 and the heat-conducting element 15 are depicted separately for illustrative purposes.

In accordance with the FIG. 22 representation, the cell 2 is of similar design to cells 2 shown in FIGS. 1 to 3 or FIGS. 9 and 10. The cell housing side pieces 2.1, 2.2 do not, however, comprise any angled sections (2.12, 2.13 or 2.22 in FIG. 6 or FIG. 8) and none of the cell housing side pieces 2.1, 2.2 support a damping element. The cell housing side pieces 2.1, 2.2 are thus substantially configured as flat plates, their height and width substantially corresponding to that of the cell housing frame 2.3 without the material protuberance 2.31. It is noted that the invention is also functional in the design of this embodiment when the cell housing side pieces 2.1, 2.2 of the cell 2 comprise curved sections and/or spring elements.

The heat-conducting element 15 is designed as a flat case having a base 15.1 and a narrow peripheral edge 15.2. The base 15.1 thereby forms a first flat side of the heat-conducting element 15 and the edge 15.2 forms four narrow sides of the heat-conducting element while an exposed edge 15.20 of edge 15.2 defines a second open flat side of the heat-conducting element 15. The heat-conducting element 15 in the present embodiment is produced as a deep-drawn part made from a material, preferably aluminum, steel or another metal, having good electrical and thermoconducting properties.

The edge 15.2 exhibits a material recess 15.3 at an upper center section. The width of the material recess 15.3 corresponds to the width of the material protuberance 2.31 of the cell housing frame 2.3 of cell 2 with play. The inner dimensions, particularly the inner height and inner width of the heat-conducting element 15, are adapted to the outer dimensions of the cell 2 with less play so that the cell 2 will fit inside the heat-conducting element 15 and can be inserted without force (see arrow “F” in FIG. 21). When the cell 2 warms and thereby expands during operation, the cell housing can then bear firmly against the edge 15.2 of the heat-conducting element 15. The height of the edge 15.2 is thereby to be dimensioned such that when the cell housing side wall 2.2 of the cell 2 bears on the base 15.1 of the heat-conducting element, edge 15.2 will not reach the other cell housing side wall 2.1.

A damping element 15.5. is arranged at the inner surface of base 15.1. Reference is made to the clarifications as provided on the damping elements 2.4, 14.2 according to the above description as to the properties of said damping element 15.5.

A plurality of cells 2 with heat-conducting elements 15 can be assembled into a cell block, a battery respectively, similar to that as depicted in FIG. 4 and FIG. 5. The heat-conducting elements 15 thereby act on the one hand as a contact between contact sections K1, K3 of successive cells and on the other hand transfer heat generated in the interior of the cells 2 via the damping elements 5.5 and the base 15.1 to the outer exposed edges 15.2 where the heat is either emitted directly to a cooling plate or conducted to a cooling plate via clamping devices. Electrical insulation between the heat-conducting elements 15 and the cooling plate or tension bands respectively (see 8 in FIG. 5 et al) is to be provided analogously to the embodiment described above in order to prevent faulty contact.

In one design variant, the inner dimensions of the heat-conducting element 15 are not dimensioned with play but rather at a slight undersize to the outer dimensions of the cell 2 so that the heat-conducting element 15 and the cell 2 are joined together with a certain force.

Although not more specifically detailed in the figure, recesses useful in accommodating and guiding tension bands can be provided.

FIG. 23 illustrates a modification of the heat-conducting element 15 according to FIG. 22 in a schematic spatial view.

In accordance with the FIG. 23 depiction, the edge 15.2 of the heat-conducting element exhibits interruptions (cuts) 15.4 at its edges such that the continuous edge 15.2 (FIG. 21) is split into two lateral edge sections 15.21, one lower edge section 15.22 and two upper edge sections 15.23. When the edge with undersize is dimensioned to cell 2, fitting force can be less with this modification since the edge sections 15.21, 15.22, 15.23 can elastically yield. During manufacture, the heat-conducting element 15 can initially be stamped or cut from a flat sheet metal piece and then bent into form. Alternatively, the heat-conducting element 15 can be deep-drawn and then cut.

Four damping elements 15.5 distributed over the inner surface of the base 15.1 are provided here as a further modification. The clarifications provided on damping elements 2.4 or 14.2 are analogously applicable to the properties of the elastic elements 15.5 of the present modification.

FIG. 24 illustrates the structure of a battery 1 as a further embodiment of the invention in a schematic spatial view. The battery 1 is composed of thirty-five individual cells 2 respectively accommodated in a heat-conducting element 15 in accordance with FIG. 22 or 23. The individual cells 2 are secondary cells (accumulator cells) having active areas containing lithium and are configured as flat-cell frames in accordance with FIG. 22. In all other respects, the battery 1 of the present embodiment can be understood as a modification of the battery shown in FIGS. 4 and 5 such that reference is made to the clarifications provided in that regard with respect to the basic fundamental structure.

Additionally to the vertical tension bands 8 which are configured from a thermally conductive material and can conduct heat from the top of the battery to the cooling plate 3, a further tension band 9 is provided which runs across the lateral sides of the individual cells 2, the heat-conducting elements 15 respectively, and encloses the battery 1 in a horizontal plane; for this reason, it is also referred to as horizontal tension band 9. For the properties of the horizontal tension band 9, reference is made to the clarifications provided on the vertical tension bands 8 according to FIG. 11. In particular, also the horizontal tension band 9 is of thermoconducting design. The horizontal tension band 9 covers tension bands 8 in the area of the pole plates 6, 7. In one design alternative, tension bands 8 cover tension band 9. In the area of the lateral narrow sides of the heat-conducting elements 15, the horizontal tension band 9 exhibits flat thermoconducting contact with same and further exhibits flat thermoconducting contact with the vertical tension bands 8 in the area of the pole plates 6, 7.

Due to the thermoconducting properties of the horizontal tension band 9 and the heat-conducting contact of the horizontal tension band 9 to the lateral narrow sides of the heat-conducting elements 15 accommodating the cells 2 and the vertical tension bands 8, a heat transfer between the cells 2 can also occur on the one hand in the lateral area of the battery as well as a heat transfer from the lateral side to the underlying cooling plate 3 via the vertical tension bands 8.

Like tension bands 8, tension band 9 can have an electrically insulating yet thermally conductive or heat permeable coating. Alternatively, an electrically insulating interlayer similar to the heat-conducting film 4 can be arranged between the pressure plate 5 and the cells 2 or the upper narrow side of the heat-conducting elements 15 respectively. Alternatively, thermally conductive or heat permeable interlayers such as for instance heat-conducting film 4 can also be provided between the vertical tension bands 8 and the pole plates 6, 7, between the horizontal tension band 9 and the heat-conducting elements 15, as well as between the horizontal tension band 9 and the pole plates 6, 7. Electrical insulation between the heat-conducting elements 15 on the one hand and the cooling plate 3, the pressure plate 5 and the tension band 9 on the other is unnecessary when the outer sides of the edges of the heat-conducting elements 15 themselves comprise an electrically insulating layer as a further embodiment variant.

In a further embodiment variant, the tension band 9 can run in not further depicted recesses in the lateral narrow sides of the heat-conducting elements 15 and the front and rear pole plates 6, 7. In a further variant, pressure plates (not further depicted) can also be provided between the tension band 9 and the lateral narrow sides of the heat-conducting elements 15.

FIG. 25 schematically illustrates the structure of a battery 1 as a further embodiment of the present invention.

The battery 1 is formed from a plurality of individual cells (cells) 2 which are arranged in three rows R1 to R3. A first row R1 is arranged adjoining a battery housing side wall 27 while the successive rows are each arranged at one respective row width further from the battery housing side wall 27. In the figure, one cell 2 is respectively depicted in each row R1 to R3 whereas the further cells of the rows are symbolized by dots. Bordering battery cells transverse to the direction of extension of rows R1 to R3 define a column Sᵢ of cells 2.

The cells 2 of the battery 1 in this embodiment are designed as cylindrical cells 2. The cells 2 of one column Sᵢ are affixed to the battery housing wall 27 by a looped tie strap 28. The tie strap 28 extends from the battery housing wall 27 and initially winds in wave-like manner around the cells 2 of column Sᵢ to cell 2 of the farthest row R3, winds around the latter in a loop and then runs back to the battery housing wall 27, whereby it again winds in wave-like manner around the cells 2 of column Sᵢ in reverse order as before. The cells 2 of a column Sᵢ are in this way held in position.

The tie strap 28 is made from a heat-conducting material. By looping the cells 2, it is in close contact with same, absorbs heat as generated in the cells 2, and transfers it to the battery housing wall 27. The battery housing wall 27 is actively or passively cooled or temperature controlled respectively.

FIG. 26 schematically illustrates the structure of a battery 1 as a further embodiment of the present invention. This embodiment is a modification of the embodiment depicted n FIG. 25. Here the cells 2 of the three rows R1 to R3 are situated between two housing side walls 27.1, 27.2. Two tie straps 28.1, 28.2 run between the housing side walls 27.1, 27.2, whereby they wind around the battery cells 2 in wave-like manner.

The tie straps 28, or 28.1, 28.1 respectively, of the battery 1 depicted in FIG. 25 or FIG. 26 are made from an elastically resilient preferably well-flexible material. This thereby achieves an elastic support between and among the individual cells 2 and to a battery housing.

It is understood that the invention is not directed toward a specific number of columns Sᵢ; in fact the invention in accordance with the embodiments described above is also applicable to batteries only having one column S of battery cells.

It is further understood that the invention is not limited to three rows R1 to R3 of battery cells 2; in fact the invention in accordance with the embodiments described above is also applicable to batteries exhibiting more or fewer rows Ri of battery cells 2.

Although FIGS. 25 and 26 indicate elongated cylindrical cells 2, a stack of flat cylindrical cells, for instance button cells or the like, can be provided in their place in one embodiment variant, same being pressed together in the axial direction by a further clamping device not more specifically detailed here.

The invention has been described above on the basis of preferred embodiments, embodiment variants and alternatives as well as modifications which for their part are likewise to be understood as preferred embodiments of the invention. So as to avoid unnecessary repetition, reference has been made to the clarifications provided on other embodiments/variants, etc. where doing so thereby lends itself. It is once again emphasized that wherever it is not obviously prohibitive, features and properties of one embodiment, variant, alternative or modification are at least analogously applicable to another embodiment, variant, alternative or modification.

All of the above-described cells, respectively individual cells 2, are storage cells or energy storage cells respectively in the sense of the invention. All of the above-described batteries 1 are energy storage apparatus in the sense of the invention. All of the above-described damping elements 2.4, 14.2, 15.5 as well as tie straps 28, 28.1, 28.2 are elastic means in the sense of the invention. The latter tie straps 28, 28.1, 28.2 are also a clamping device in the sense of the invention, just as the above-described tension bands 8, 9 and tension bars 20 with nuts 21, retaining frame 16, 17 and pressure frame 18, 19. All the components of the above description involved in heat dissipation, particularly cooling plates 3, heat-conducting elements 14, 15 and all the heat-conducting damping elements 2.4, 14.2, 15.5, are functional components of temperature control in the sense of the invention. The cooling plates 3 of the above description are heat exchanger devices in the sense of the invention. The above-described shells 2.41, 2.42, inner shell 2.2a and outer shell 2.2b are heat-conducting casings in the sense of the invention.

### LIST OF REFERENCE NUMERALS

1 battery cell
2 cell
2.1 cell housing side wall
2.11 measuring connection
2.12 folded edge
2.13 tab
2.2 cell housing side wall
2.2a inner shell
2.2b outer shell
2.4 damping element
2.22 tab
2.3 cell housing frame
2.31 material protuberance
2.32 upper narrow side
2.33, 2.34 material recess
2.4 damping element
2.41, 4.42 shell
2.43 seam
2.44 interior space
2.45 bellows structure
2.46 foam block
2.5 electrode stack
2.51 electrode film
2.52 conductor tab
2.6 pole contact (current conductor)
2.7 sealed seam
2.71 passage area
2.72 beading
2.8 flat side
3 cooling plate
3.1 coolant connection
3.2 recess
3.3 coolant channel
4 heat-conducting film
5 pressure plate
5.1 recess
6 front pole plate
7 rear pole plate
6.1, 7.1 tab-like extension
6.2, 7.2 fastening tab
7.3 recess
8 clamping element (vertical tension band)
8.1 clamping area
8 horizontal tension band
10, 11 electrical connector element
13 electronic component
13.1 device for monitoring cell voltage
13.2 device for equalizing cell voltage
13.3 contact element
14 heat-conducting element
14.1 carrier structure
14.11 long limb
14.12 short limb
14.2 damping element
14.21 resilient material
14.22 casing
15 heat-conducting element
15.1 base
15.2 edge
15.20 edge
15.21, 15.22, 15.23 lateral edge section
15.3 recess
15.4 cut
15.5 damping element
15 base plate
16, 17 retaining frame
16.1, 17.1 folded edge
18, 19 end plate
18.1, 19.1 folded edge
20 tension bar
21 nut
22, 23, 24 connection device
25 strut
26 control device
27, 27.1, 27.2 housing wall
28, 28.1, 28.2 tie strap
A1 coolant contact surface
A2 cell contact surface
B bending direction
D compressive force
E1 first cell
E2 last cell
F joining direction
K1 to K3 voltage connection contacts
P+ positive pole
P− negative pole
P_{neg} negative pole connection
Pₚₒₛ positive pole connection
R1 to R3 cell rows
Sᵢ cell column
W thermal flow
Z cell assembly
b, w width
d thickness
h, h1, h2 height
s stacking direction
t depth, thickness

It is noted that the above list of reference numerals is an integral part of the description.

1-16. (canceled)

17. An energy storage apparatus comprising:
a plurality of storage cells;
a temperature control device configured to control the temperature of the storage cells or a cell assembly formed by the storage cells; and
elastic means are provided between a storage cell of the plurality of storage cells and another component for a shock-absorbing supporting or spacing, wherein the other component is another storage cell of the plurality of storage cells or a retaining element or another housing part or a heat-conducting element, wherein the elastic means is configured to exert a defined pressure on one or more of the storage cells.

18. The energy storage apparatus according to claim 17, wherein the value of the defined pressure is within a specific range, the energy storage apparatus configured such that an upper limiting value and a lower upper limiting value of the range are not exceeded or fallen short of, respectively, during the intended operation of the energy storage apparatus.

19. The energy storage apparatus according to claim 17, wherein at least one elastic means is convexly or concavely adapted to the shape of the cells so that the pressure exerted by said elastic means is changed or sustained such that said elastic means exerts a pressure on one or more of the storage cells which has a value within a specific range, the upper limiting value and lower upper limiting value of which are not exceeded or fallen short of, respectively, during the intended operation of the energy storage apparatus.

20. The energy storage apparatus according to claim 17, wherein at least one of the elastic means is configured such that the outer form and the size of the contact surface or surfaces of the at least one elastic means with its environment changing upon the change in form of at least one storage cell such that the pressure exerted by the elastic means onto its environment via said contact surface or surfaces is within a specific range, an upper or lower limiting value of the specific range not being exceeded or fallen short of, respectively, during the intended operation of the inventive energy storage apparatus.

21. The energy storage apparatus according to claim 17, wherein at least one of the elastic means is realized in such a manner as to result in a constant pressure in its interior.

22. The energy storage apparatus according to claim 21, wherein at least one elastic means is realized in such a manner as to result in a mass being coupled to a gas volume filling the interior of the elastic means under the influence of its own weight force such that the gas volume in the interior of the elastic means remains under a constant pressure.

23. The energy storage apparatus according to claim 21, wherein the elastic means is partially filled with a liquid which is in equilibrium with its vapor at the prevailing temperature so that the vapor of said liquid fills the part of the interior volume of the elastic means which is not filled by the liquid.

24. The energy storage apparatus according to claim 17, wherein the elastic means is configured as a functional component of the temperature control device.

25. The energy storage apparatus according to claim 17, wherein the elastic means comprises a heat-conducting shell and an interior space, wherein the interior space is filled with an elastically resilient material.

26. The energy storage apparatus according to claim 17, wherein the elastic means comprises a heat-conducting or heat permeable shell and an interior space, wherein the interior space is filled with a heat-conducting and elastically resilient material.

27. The energy storage apparatus according to claim 17, wherein the elastic means bears at least partially on the heat exchange surfaces of the storage cells.

28. The energy storage apparatus according to claim 17, wherein the elastic means is electrically conductive.

29. The energy storage apparatus according to claim 17, wherein the elastic means is electrically insulating.

30. The energy storage apparatus according to claim 17, wherein the elastic means is affixed to respective storage cells or formed as an integral component of respective storage cells.

31. The energy storage apparatus according to claim 17, wherein the elastic means is affixed to respective heat-conducting elements, at least sections of which are arranged between respective storage cells, or the elastic means is formed as an integral component of such heat-conducting elements.

32. The energy storage apparatus according to claim 17, wherein the temperature control device comprises a heat exchanger and heat-conducting elements, at least sections of which are arranged between respective storage cells, the heat-conducing elements having heat-conducting contact to the heat exchanger device.

33. The energy storage apparatus according to claim 17, further comprising a clamping device configured to brace the storage cells.

34. An energy storage cell comprising:
an active part; and
an enclosure encasing said active part as well as elastic means affixed to the storage cell or formed as an integral component thereof and configured and arranged for the shock-absorbing supporting or spacing of the storage cell relative to other components, wherein the elastic means is configured and arranged to conduct heat, wherein said elastic means is configured so as to exert a defined pressure on one or more of the storage cells.

35. A heat-conducting element for arrangement between energy storage cells, comprising:
An elastic member affixed to said heat-conducting element or formed as an integral component of same and which is configured and arranged to conduct heat, wherein said elastic means is configured so as to exert a defined pressure on one or more storage cells.

36. The heat-conducting element according to claim 35, further comprising:
a thin-walled support structure configured to receive an energy storage cell, wherein the thin-walled structure defines a form of a cuboid, and wherein the thin-walled structure includes at least one flat side and at least two narrow sides flanking the at least one flat side.
